(19) United States
(12) Patent Application Publication
(10) Pub. No.: US 2022/0215357 A1
(43) Pub. Date: Jul. 7, 2022

(54) SYSTEMS, APPARATUSES, INTERFACES, AND APPLICATIONS OF PERSON SPECIFIC FUNDING INSTRUMENTS ON SPECIFIED CELEBRATION DAYS AND METHODS FOR IMPLEMENTING AND USING SAME

(71) Applicants: Paul Ashley, Brazoria, TX (US); Brooke Ashley, Brazoria, TX (US); Paul Ronald Ashley, SR., Lake Jackson, TX (US)

(72) Inventors: Paul Ashley, Brazoria, TX (US); Brooke Ashley, Brazoria, TX (US); Paul Ronald Ashley, SR., Lake Jackson, TX (US)

(21) Appl. No.: 17/526,665

(22) Filed: Nov. 15, 2021

Related U.S. Application Data
(60) Provisional application No. 63/114,543, filed on Nov. 17, 2020.

(51) Int. Cl. G06Q 20/10; G06Q 20/40; G06Q 20/32

(52) U.S. Cl. CPC G06Q 20/10; G06Q 20/321; G06Q 20/3223; G06Q 20/4014

(57) ABSTRACT

Systems, apparatuses, interfaces, and applications and method implementing them configured to setup a parent and child information, select specific child funding instruments and select specific celebration days so that relatives and friends may contribute funds to the selected child funding instruments on one or more of the selected celebration days.

### RELATED APPLICATIONS

This application claims provisional priority and the benefit of United States Provisional Patent Application Serial No. filed Nov. 17, 2020 (17 Nov. 2020).

### BACKGROUND OF THE DISCLOSURE

### 1. Field of the Disclosure

Embodiments of the present disclosure relate to systems, apparatuses, interfaces, and applications for selecting specific funding instruments for user entered persons such as children, persons to be married, persons retiring, and/or other persons and selecting specific celebration days so that relatives and friends may contribute funds to the selected person funding instruments on one or more of the selected celebration days and methods for implementing and using same.

In particular, embodiments of the present disclosure relate to systems, apparatuses, interfaces, and applications for selecting specific funding instruments for user entered persons such as children, persons to be married, persons retiring, and/or other persons and selecting specific celebration days so that relatives and friends may contribute funds to the selected person funding instruments on one or more of the selected celebration days and methods for implementing and using same, wherein the systems, apparatuses, interfaces, and applications include one or more display devices, one or more input devices, and one or more output devices and one or more processing units in communication with the devices and wherein the systems, apparatuses, interfaces, and applications are in communication with distributed computing network such as the worldwide web or the internet and wherein the processing unit is configured to active the application, establish user names and passwords, gather relevant user information, register persons, select funding instruments, select celebration days, notify relatives and/or friends on the celebration days with a website link and person specific code, allow relatives and/or friends to access person funding pages via the website and person specific code, and accept funds for the selected instruments.

### 2. Description of the Related Art

While there are numerous systems in the prior art for setting up funding instruments for user entered persons such as children, persons to be married, persons retiring, and/or other persons, there is still a need in the art for an application that allows parents to select funding instruments for user entered persons such as children, persons to be married, persons retiring, and/or other persons and specific celebration days so that relatives and friends may contribute funds to the selected funding instruments on one or more of the specific celebration days.

### SUMMARY OF THE DISCLOSURE

Embodiments of this disclosure provide systems, apparatuses, interfaces, and applications including one or more processing units, one or more display units, one or more input devices, and optionally one or more additional output devices associated with stationary, mobile, and/or wearable devices in communication with a distributed computer network such as the world wide web or the Internet, wherein the systems, apparatuses, interfaces, and/or applications are configured to: install the application on the stationary, mobile, and/or wearable devices; activate the systems, apparatuses, interfaces, and applications; establish login and password identification; enter user data; enter person specific data such as children, persons to be married, persons retiring, and/or other persons; enter person specific celebration days; enter person general celebration days; enter relative data; enter friend data; and enter person specific funding options. Once data entry is complete, the systems, apparatuses, interfaces, and/or applications are further configured to: monitor the entered celebration days and send a website link and a person specific code to the entered relatives and friends for each celebration day. Once the relatives and friends have received the website link and person specific code, the systems, apparatuses, interfaces, and/or applications are further configured to: each notified relatives and friends, proceeds to the website; enters the person specific code; selects a funding options; enters an amount to be donated; enters card, account, or alternate fund transfer form; and transfers the entered amount of funds to the selected funding option.

Embodiments of this disclosure provide methods implemented on computers, mobile devices, and/or wearable devices in communication with a distributed computer network such as the world wide web or the internet, wherein the methods include: installing the systems, apparatuses, interfaces, and applications on the stationary, mobile, and/or wearable devices; activating the systems, apparatuses, interfaces, and applications; establishing login and password identification; entering parent data; entering person specific data as children, persons to be married, persons retiring, and/or other persons; entering person specific celebration days; entering person general celebration days; entering relative data; entering friend data; and entering person specific funding options. Once data entry is complete, the method further include: monitoring the entered celebration days and sending a website link and a person specific code to relatives and friends for each celebration day. Once the relatives and friends have received the website link and person specific code, the methods further include: for each interested relative or friend, proceeding to the website link; entering the person specific code; selecting a person specific funding options; entering an amount to be donated; entering card, account, or alternate funds form; and transferring the entered amount of funds to the selected funding option.

### BRIEF DESCRIPTION OF THE DRAWINGS OF THE DISCLOSURE

The disclosure may be better understood with reference to the following detailed description together with the appended illustrative drawings in which like elements are numbered the same:

FIG. 1 depict is a schematic of a system, apparatus, interface, and/or application in communication with a distribution computing environment such as the worldwide web or the Internet.

FIG. 2A depicts illustrative high level conceptual flow diagrams of a method implementing the systems, apparatuses, interfaces, and/or applications for entering data and sending out celebration day notifications.

FIG. 2B depict illustrative high level conceptual flow diagrams of a method implementing the systems, apparatuses, interfaces, and/or applications for relative and friend for transferring funds to a selected funding options.

FIGS. 3A-B depict stationary device and mobile device showing a highlighted icon for an interface or application of this disclosure implemented in or on a stationary device, mobile device, and/or wearable device.

FIGS. 4A-H depict a screen shot sequence for performing certain aspects of the systems, apparatuses, interfaces, and/or applications and methods implementing them.

FIGS. 5A-AB depict a screen shot sequence for performing other aspects of the systems, apparatuses, interfaces, and/or applications and methods implementing them.

FIGS. 6A-M depict a screen shot sequence for performing other aspects of the systems, apparatuses, interfaces, and/or applications and methods implementing them.

FIGS. 7A-G depict a screen shot sequence for performing other aspects of the systems, apparatuses, interfaces, and/or applications and methods implementing them.

### DEFINITIONS USED IN THE DISCLOSURE

The term “at least one”, “one or a plurality”, or “one or more” means one and two or more or one or a plurality, additionally, these three terms may be used interchangeably within this application. For example, at least one device means one or more devices or one or a plurality of devices.

The term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value. In this disclosure, all subranges are includes and the end points are included.

The term “substantially” means that a value of a given quantity is within ±5% of the stated value. In other embodiments, the value is within ±2.5% of the stated value. In other embodiments, the value is within ±2% of the stated value. In other embodiments, the value is within ±1% of the stated value. In other embodiments, the value is within ±0.1% of the stated value. In this disclosure, all subranges are includes and the end points are included.

The term “selectable object”, “selectable item”, and “selectable icon” mean collectively any display element that may be selected by any selection methodology including motion based selection methodologies, gesture based selection methodologies, and/or hard selection based methodologies.

The term “motion based selection methodologies” mean any selection methodology based solely on user sensed motion.

The term “gesture based selection methodologies” mean any selection methodology based on capturing a gesture, confirming the gesture is acceptable, looking up an associated selectable object, item, or icon.

The term “hard selection based methodologies” mean any selection methodology that requires a specific select event such as a lift off event, a touch down event, a click, a double click, a tap, a double tap, or any other event that immediately causes an object, item, or icon selection.

In this disclosure, all ranges include all subranges.

### DETAILED DESCRIPTION OF THE DISCLOSURE

The inventors have found that systems, apparatuses, interfaces, and applications and methods implementing them may be constructed to allow user such as parents to set up funding options for persons such as children, persons to be married, persons retiring, and/or other persons so that relatives and friends to transfer funds to the funding options set up by the users, wherein the funding options may include a life insurance policy, an annuity, a bank account such as a checking account, a saving account, a money market account, etc., an individual retirement account such as a traditional IRA, a Roth IRA, etc., a college account, a car account, a housing account, a prepaid credit card, a money order, or any other fundable instrument. The systems, apparatuses, interfaces, and/or applications and methods implementing them accomplishes the funding process for each celebration day entered into the systems, apparatuses, interfaces, and/or applications by a user such as a parent and sends a website link and a person specific code to each entered relative or friend allowing each entered relative or friend to go to the website link, enter the person specific code, and transfer funds to one or more parent entered funding options. The use of a website link and person specific code is to protect the users, entered persons, entered relatives, and entered friends from outsiders attempting to view the user, entered person, entered relatives, and entered friends data. The website link and person specific code simply allow notified relatives and friends to enter funds to one or more parent entered funding options using the person specific code at the sent website link.

Embodiments of this disclosure broadly relate to systems, apparatuses, interfaces, and/or applications including one or more processing units, one or more display units, one or more input devices, and one or more additional output devices associated with stationary, mobile, and/or wearable devices in communication with a distributed computer network such as the world wide web or the Internet, wherein the systems, apparatuses, interfaces, and/or applications are configured to: install the application on one or more stationary, mobile, and/or wearable devices; activate the systems, apparatuses, interfaces, and/or applications; enter login and password information; enter user data; enter person specific data; enter specific celebration days; enter general celebration days; enter relative data; enter friend data; and enter funding options. In certain embodiments, the persons are children, persons to be married, persons retiring, and/or other persons. Once data entry is complete, the systems, apparatuses, interfaces, and/or applications are further configured to: monitor the entered celebration days and send a website link and a person specific code to relatives and friends for each celebration day and for each relative and friend. Once the relatives and friends have received the website link and person specific code, the systems, apparatuses, interfaces, and/or applications are further configured to: proceed to the website; enter the person specific code; select a funding options; enter amount to be donated; enter card, account, or alternate funds mechanism; and transfer the entered amount of funds to the selected funding option.

Embodiments of this disclosure broadly relate to methods implemented on computers, mobile devices, and/or wearable devices in communication with a distributed computer network such as the world wide web or the internet, wherein the methods include: installing the systems, apparatuses, interfaces, and/or applications on the stationary, mobile, and/or wearable devices; activating the systems, apparatuses, interfaces, and/or applications; entering login and password information; entering user data; entering person specific data; entering specific celebration days; entering general celebration days; entering relative data; entering friend data; and entering funding options. Once data entry is complete, the methods further include: monitoring the entered celebration days and sending a website link and a person specific code to the entered relatives and friends for each celebration day. Once the relatives and friends have received the website link and a person specific code, the methods further include: for each relative or friend, proceeding to the website link; entering the person specific code; selecting a funding options; enter an amount to be donated; entering card, account, or alternate funds mechanism; and transferring the entered amount of funds to the selected funding option.

In certain embodiments, the systems, apparatuses, interfaces, and/or applications and methods implementing them are configured to be funding by a number of different methods including (a) an annual fee, semi-annual fee, or a monthly fee per user, (b) a fee for each funding transaction, (c) an annual fee, semi-annual fee, or a monthly fee based on a percentage of the value of funds in each funding option, (d) a fee for each policy, account, or other funding option opened via the systems, apparatuses, interfaces, and/or applications and methods implementing them, or (e) any combination thereof.

In certain embodiments, the systems, apparatuses, interfaces, and/or applications include user devices, relative devices, friend devices, and servers. The user devices are configured to install an application onto a user device, open the application on the user device, if the user is a first time user, then: enter a user name, a user password, a user phone number, and a user email address into server databases, enter user data and user payment method data into the server databases, enter specific person data, specific person celebration days, specific person funding options, person relatives data, and person friends data into the server databases, if all persons have not been entered, repeat enter specific person data, specific person celebration days, specific person funding options, person relatives data, and person friends data into the server databases, and if all persons have been entered, then modify entered data in the server databases. The servers are configured to test for a celebration day in the server databases, and if a celebration day is detected, determine the person associated with the celebration day and send a website link and a person specific code, otherwise continue to test for a celebration day. The devices of the relatives and friends are configured to receive the website link and the person specific code, display the funding options associated with the person specific code, select a funding option, enter an amount of funds to be transferred to the selected funding option, display payment types, select a funding type, enter information associated with the selected funding type, transfer the amount of funds, and receive a funds transfer confirmation. The servers are further configured to continue to test for a celebration day. In other embodiments, the servers are further configured to after the entering the user name, the user password, the user phone number, and the user email address, verifying user identify including selecting a verification mode, sending a verification code, entering the verification code, and if the verification code is incorrect, then stopping the method. In other embodiments, the servers are further configured to after the entering the amount of funds, verifying relative or friend identify including selecting a verification mode, sending a verification code, entering the verification code, and if the verification code is incorrect, then stopping the method. In other embodiments, the systems, apparatuses, interfaces, applications, and/or servers include links to third party social media platforms so that the systems, apparatuses, interfaces, applications, and/or servers may pull contact information of friends and relatives or push notification content to the third party social media platforms for distribution to relatives and friends resident on the social media platforms, wherein the social media platforms include FaceBook, Instragram, WhatsApp, QQ, WeChat, Qzone, Tumblr, Twitter, Google+, Baidu Tieba, Skype, Viber, Sina Weibo, LINE, Snapchat, YY, VKontakte (VK), Pinterest, LinkedIn, Telegram, Reddit, Taringa, TikTok, Foursquare, Renren, Tagged, Badoo, Myspace, Mix, The Dots, Kiwibox, Skyrock, Delicious, Snapfish, ReverbNation, Flixster, Care2, CafeMom, Ravelry, Nextdoor, Wayn, Cellufun, YouTube, Upstream, Classmates, MyHeritage, Viadeo, Xing, Xanga, LiveJournal, Friendster, Funny or Die, Gaia Online, We Heart It, Buzznet, DeviantArt, Flickr, MeetMe, MeWe, Meetup, Tout, Mixi, Douban, Vero, Quora, Spreely, Discord, WT Social, Triller, Elpha, Yubo, PopBase, Peanut, Valence, Flip, HouseParty, Caffeine, Steemit, Goodreads, Twitch, CaringBridge, WattPad, Crunchyroll, Soundcloud, Mocospace, CouchSurfing, italki, Medium, Ello, Vimeo, Giphy, Tribe, Kuaishou, Imgur, Influenster, FilmAffinity, Open Diary, Bubbly, other similar social media platforms, or any combination thereof.

In certain embodiments, the methods implementing the systems, apparatuses, interfaces, and/or applications include installing an application on a user device and opening and activating with the application on the user device. The methods also include if the user is a first time user, then entering a user name, a user password, a user phone number, and a user email address, entering user data and user payment method data, entering specific person data, specific person celebration days, specific person funding options, person relatives data, and person friends data, if all persons have not been entered, repeating entering specific person data, specific person celebration days, specific person funding options, person relatives data, and person friends data, and if all persons have been entered, then modifying entered data. The methods also include on databases associated the servers, testing for a celebration day, if a celebration day is detected, determining the person associated with the celebration day and sending a website and a person specific code, otherwise continue testing for a celebration day. The methods also include once the website link and person specific code is received on a relative or friend device, entering the website link and the person specific code, displaying the funding options associated with the person specific code on the relative or friend device, selecting a funding option, entering an amount of funds to be transferred to the selected funding option, displaying payment types, selecting a funding type, entering information associated with the selected funding type, submitting payment, and sending payment confirmation to the relative or friend device. The methods also include returning to testing for a celebration day. In other embodiments, the methods further includes after the entering the user name, the user password, the user phone number, and the user email address, verifying user identify including selecting a verification mode, sending a verification code, entering the verification code, and if the verification code is incorrect, then stopping the method. In other embodiments, the methods also include after the entering the amount of funds, verifying relative or friend identify including selecting a verification mode, sending a verification code, entering the verification code, and if the verification code is incorrect, then stopping the method.

In certain embodiments, the methods implementing the systems, apparatuses, interfaces, and/or applications include

### Suitable Components for Use in the Disclosure

### Motion Sensors

Suitable motion sensors include, without limitation, optical sensors, acoustic sensors, thermal sensors, optoacoustic sensors, wave form sensors, pixel differentiators, or any other sensor or combination of sensors that are capable of sensing movement or changes in movement, or mixtures and combinations thereof. Suitable motion sensing apparatus include, without limitation, motion sensors of any form such as digital cameras, optical scanners, optical roller ball devices, touch pads, inductive pads, capacitive pads, holographic devices, laser tracking devices, thermal devices, electromagnetic field (EMF) sensors, wave form sensors, any other device capable of sensing motion, changes in EMF, changes in a wave form, or the like or arrays of such devices or mixtures or combinations thereof. The sensors may be digital, analog, or a combination of digital and analog. The motion sensors may be touch pads, touchless pads, touch sensors, touchless sensors, inductive sensors, capacitive sensors, optical sensors, acoustic sensors, thermal sensors, optoacoustic sensors, electromagnetic field (EMF) sensors, strain gauges, accelerometers, pulse or waveform sensor, any other sensor that senses movement or changes in movement, or mixtures and combinations thereof. The sensors may be digital, analog, or a combination of digital and analog or any other type. For camera systems, the systems may sense motion within a zone, area, or volume in front of the lens or a plurality of lens. Optical sensors include any sensor using electromagnetic waves to detect movement or motion within in active zone. The optical sensors may operate in any region of the electromagnetic spectrum including, without limitation, radio frequency (RF), microwave, near infrared (IR), IR, far IR, visible, ultra violet (UV), or mixtures and combinations thereof. Exemplary optical sensors include, without limitation, camera systems, the systems may sense motion within a zone, area or volume in front of the lens. Acoustic sensor may operate over the entire sonic range which includes the human audio range, animal audio ranges, other ranges capable of being sensed by devices, or mixtures and combinations thereof EMF sensors may be used and operate in any frequency range of the electromagnetic spectrum or any waveform or field sensing device that are capable of discerning motion with a given electromagnetic field (EMF), any other field, or combination thereof. Moreover, LCD screen(s), other screens and/or displays may be incorporated to identify which devices are chosen or the temperature setting, etc. Moreover, the interface may project a virtual control surface and sense motion within the projected image and invoke actions based on the sensed motion. The motion sensor associated with the interfaces of this disclosure may also be acoustic motion sensor using any acceptable region of the sound spectrum. A volume of a liquid or gas, where a user's body part or object under the control of a user may be immersed, may be used, where sensors associated with the liquid or gas can discern motion. Any sensor being able to discern differences in transverse, longitudinal, pulse, compression or any other waveform may be used to discern motion and any sensor measuring gravitational, magnetic, electro-magnetic, or electrical changes relating to motion or contact while moving (resistive and capacitive screens) could be used. Of course, the interfaces can include mixtures or combinations of any known or yet to be invented motion sensors. The motion sensors may be used in conjunction with displays, keyboards, touch pads, touchless pads, sensors of any type, or other devices associated with a computer, a notebook computer or a drawing tablet or any mobile or stationary device, and/or device, head worn device, or stationary device.

Suitable motion sensing apparatus include, without limitation, motion sensors of any form such as digital cameras, optical scanners, optical roller ball devices, touch pads, inductive pads, capacitive pads, holographic devices, laser tracking devices, thermal devices, EMF sensors, wave form sensors, MEMS sensors, any other device capable of sensing motion, changes in EMF, changes in wave form, or the like or arrays of such devices or mixtures or combinations thereof. Other motion sensors that sense changes in pressure, in stress and strain (strain gauges), changes in surface coverage measured by sensors that measure surface area or changes in surface are coverage, change in acceleration measured by accelerometers, or any other sensor that measures changes in force, pressure, velocity, volume, gravity, acceleration, any other force sensor or mixtures and combinations thereof.

### Processing Units

Suitable processing units for use in the present disclosure include, without limitation, digital processing units (DPUs), analog processing units (APUs), Field Programmable Gate Arrays (FPGAs), any other technology that may receive motion sensor output and generate command and/or control functions for objects under the control of the processing unit, and/or mixtures and combinations thereof.

Suitable digital processing units (DPUs) include, without limitation, any digital processing unit capable of accepting input from a plurality of devices and converting at least some of the input into output designed to select and/or control attributes of one or more of the devices. Exemplary examples of such DPUs include, without limitation, microprocessor, microcontrollers, or the like manufactured by Intel, Motorola, Ericsson, HP, Samsung, Hitachi, NRC, Applied Materials, AMD, Cyrix, Sun Microsystem, Philips, National Semiconductor, Qualcomm, or any other manufacture of microprocessors or microcontrollers, and/or mixtures or combinations thereof.

Suitable analog processing units (APUs) include, without limitation, any analog processing unit capable of accepting input from a plurality of devices and converting at least some of the input into output designed to control attributes of one or more of the devices. Such analog devices are available from manufacturers such as Analog Devices Inc.

### User Feedback Units

Suitable user feedback units include, without limitation, cathode ray tubes, liquid crystal displays, light emitting diode displays, organic light emitting diode displays, plasma displays, touch screens, touch sensitive input/output devices, audio input/output devices, audio-visual input/output devices, holographic displays and environments, keyboard input devices, mouse input devices, optical input devices, and any other input and/or output device that permits a user to receive user intended inputs and generated output signals, and/or create input signals.

### Devices

Suitable devices include, without limitation, stationary devices such as desk top computers, servers, etc.; mobile devices such as lap top computers, tablet computers, smart phones, PDAs, etc.; wearable devices such as watches, flexible wearable computing devices, etc.; and any other computing devices.

### DETAILED DESCRIPTION OF THE DRAWINGS OF THE DISCLOSURE

### A System Embodiment

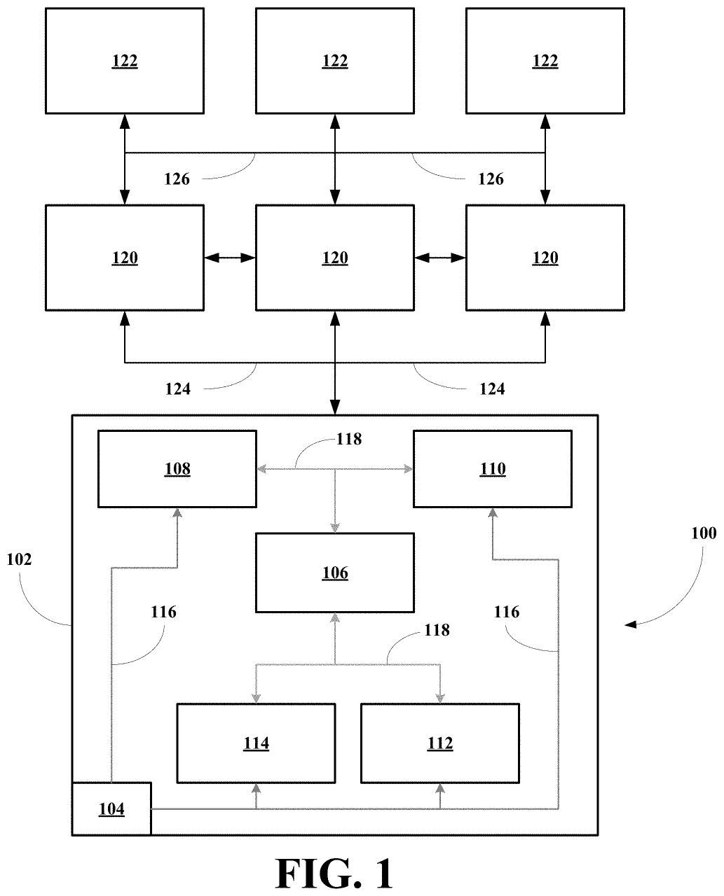

Referring now to FIG. 1, an embodiment of a system or apparatus of this disclosure, generally 100, is shown to include a user device 102 including a power supply 104, one or more processing units 106, one or more memory and mass storage units 108, one or more input units 110, one or more output units 112, and one or more communication units 114. The power supply 104 supplies power to the units 106, 108, 110, 112, and 114 via power conducing pathways 116. The one or more processing units 106 are in bilateral communication with the units 108, 110, 112, and 114 via communication pathways 118.

The system 100 also includes web-based servers 120 and other user devices 122. The user device 102 is in bilateral communication with one or more or all of the web-based servers 120 via bilateral communication pathways 124. Each of the other user devices 124 are in communication with one or more or all of the web-based servers 120 via bilateral communication pathways 126.

It should be recognized that the servers 120 and the other user devices 122 will generally include the same or more of the components of the user device 102, additionally the servers 120, the user device 102, and the other user devices 122 include operating systems as well as communication software associated with the communication unit 114. Further, the servers 120 includes databases and database software for entering and retrieving information and data from the servers 120 and sending notices to relatives and friends at each celebration day.

### Conceptual Flow Chart for Data Entry for Parent and Children

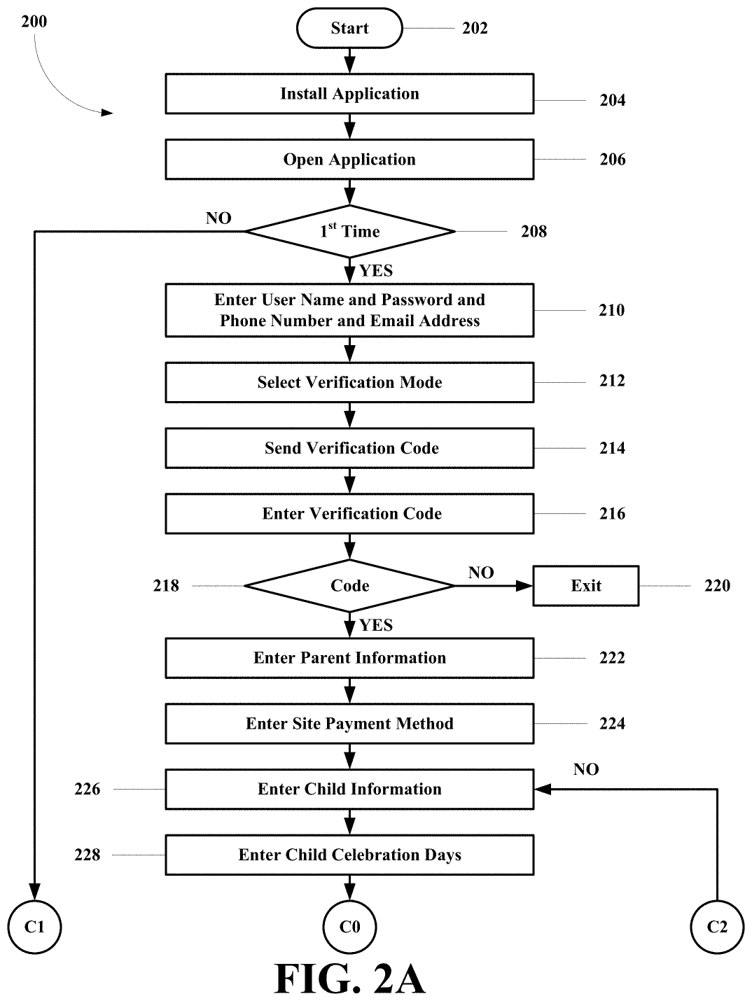

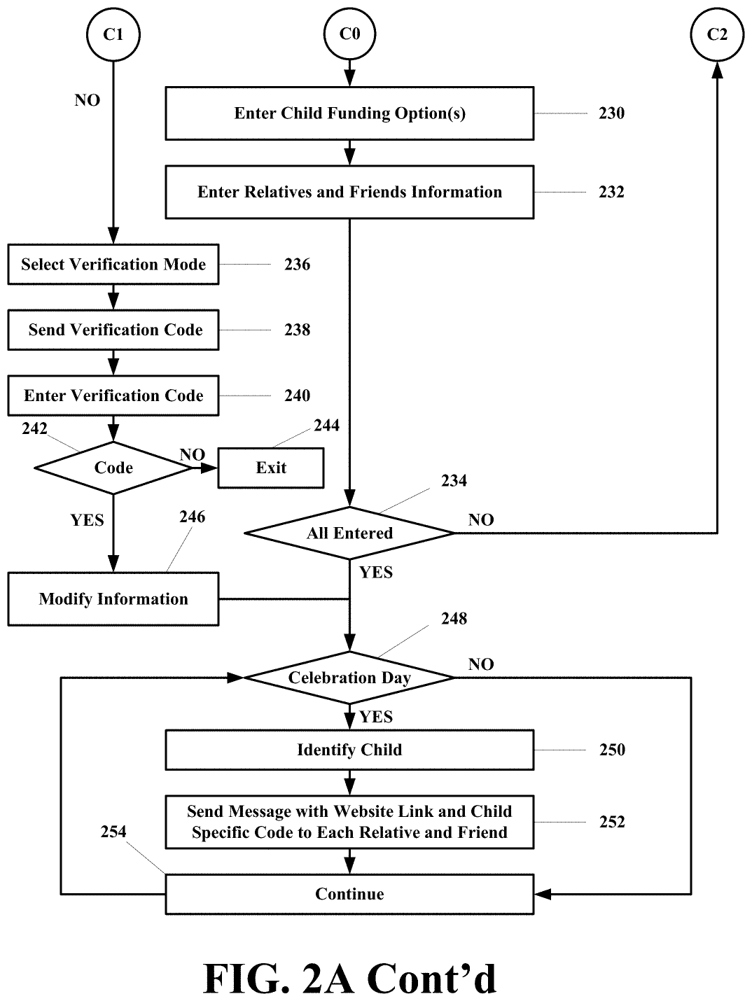

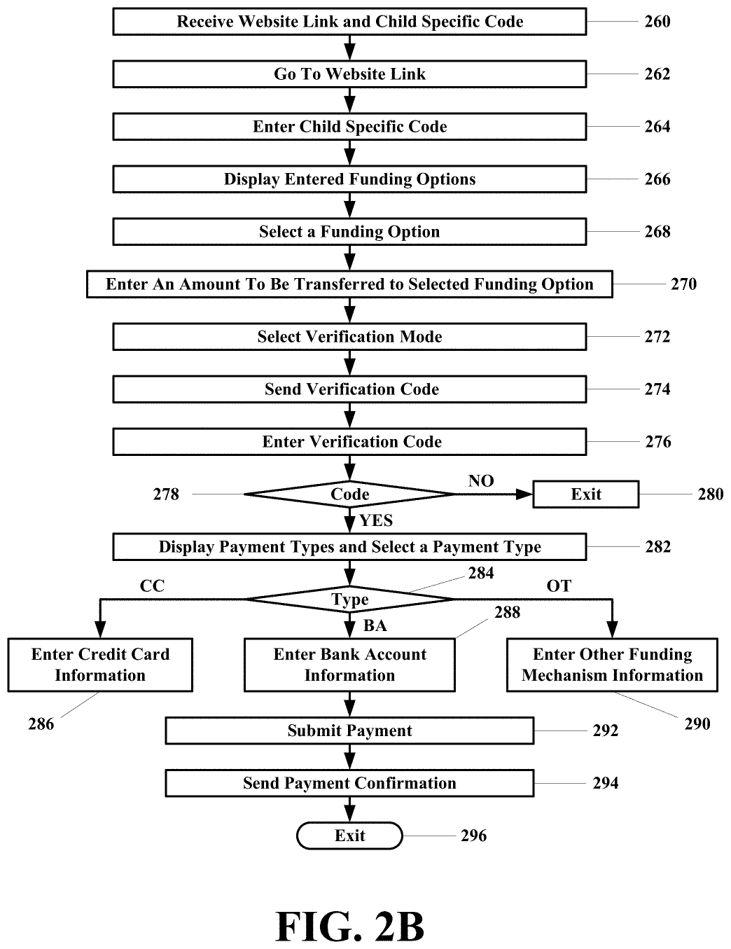

Referring now to FIG. 2A, an embodiment of a conceptual flow chart of a method implementing the systems, apparatuses, interfaces, and/or applications, generally 200, is shown to include a start step 202, which generally is simply the activation on the user device 102 to make sure that it is awake and ready for receive input data. The method 200 includes installing the application on the user device 102 in an install application step 204. If the application is already installed on the user device 102, the method 200 by passed the install set and proceeds to opening or activating with the application in an open/activate application step 206, which may be selecting an icon associated with the application or via any other activation procedure.

The method 200 then checks whether the user is a first time user in a 1st time step 208. If the user has been in the application before, then the method 200 proceeds along a NO path to continuation element C1 and onto steps described below.

If user is a first time user, then the method 200 processes along a YES path to series of data entry steps. The first data entry step 210 involves entering a user name and password and phone number and email address. The method 200 also includes selecting a verification mode in a select verification mode step 212 and sending a verification code in a send verification code step 214. The method 200 also includes entering the verification code in an enter verification code step 216. The method 200 also includes testing the verification code in a test code step 218. If the entered code is incorrect, then the method 200 proceeds along a NO path to an exit step 220.

If the entered code is correct, then the method 200 proceeds along a YES path to enter parent information in an enter parent information data step 222. The next data entry step 224 involves entering payment method information. The next data entry step 226 involves entering a child information. The next data entry step 228 involves entering child celebration days.

The method 200 is also shown to include continuation elements C0 and C2, which link two figure pages together.

The next data entry step 230 involves entering one or more child funding options. The next data entry step 232 involves entering child relative and friend information. The method 200 also includes an all entered test step 234. If all of the children have not been entered, then the method 200 proceeds along a NO path to the continuation element C2, which is linked to that enter child step 226.

The continuation element C1 is linked to the NO path of the 1^{st} time test step 208 and proceeds to selecting a verification mode in a select verification mode step 236. The method 200 also includes sending a verification code in a send verification code step 238. The method 200 also includes entering the verification code in an enter verification code step 240. The method 200 also includes testing the verification code in a test code step 242. If the entered code is incorrect, then the method 200 proceeds along a NO path to an exit step 244. If the entered code is correct, then the method 200 proceeds along a YES path to modifying entered information in a modify information step 246 and then to a celebration day test step 248, and if all the children have been entered, then the method 200 proceeds along a YES path to the celebration test step 248.

The celebration day test step 248 of the method 200 is designed to run on the servers 120 housing the system, apparatus, interface, and/or application databases. If an entered celebration day is detected by the celebration day test step 248 on one or more or all of the servers 120, then method 200 proceeds along a YES path to an identify child step 250, then to a send message to the entered relatives and friends including a website link and child specific code in a send step 252, and finally to a continue step 254, which returns control back to the celebration day test step 248. If no celebration day is detected by one or more or all of the servers 120, then the method 200 proceeds along a NO path to the continuation step 254, which again returns control back to the celebration day test step 248. Clearly, the part of the systems, apparatuses, interfaces, and/or applications running on the servers 120 is configured to monitor data in the database(s) and send celebration day notifications for all celebration days entered into the database(s). Many notifications may go out on any given celebration day including child specific celebration days and general celebration days.

### Conceptual Flow Chart for Relative and Friend Fund Entry

Referring now to FIG. 2B, the method 260 further include the step associated with relatives and friends interacting with the method 260 after a notification has been sent to each of the entered relatives or friends. The method 260 includes receiving the send notification including the website link and child specific code in a receive step 260. The method 260 also a relative or friend going to the website link in a go to website link step 262. The method 260 also include a relative or friend entering the child specific code in an enter child specific code step 264. The method 260 also include a step of displaying the funding options for the child associated with the child code in a display funding options step 266. The method 260 also include a step of selecting a funding option in a select funding option step 268. The method 260 also include a step of entering an amount of funds to be transferred to the selected funding option in an enter amount step 270.

The method 260 also include selecting a verification mode in a select verification mode step 272. The method 260 also includes sending a verification code in a send verification code step 274. The method 260 also includes entering the verification code in an enter verification code step 276. The method 260 also includes testing the verification code in a test code step 278. If the entered code is incorrect, then the method 260 proceeds along a NO path to an exit step 280.

If the entered code is correct, then the method 260 proceeds along a YES path to displaying and selecting payment types and select a funding site a display and select funding type step 282. The method 260 also include a type conditional branching step 284. If the funding type is a credit, debit, or other funds card, then process is transferred along a CC path to an enter card information step 286. If the funding type is a bank account or other type of account, then process is transferred along a BA path to an enter bank account information step 288. If the funding type is a other type of funding type, then process is transferred along an OT path to an enter other funding type information step 290, such as PayPal®, ApplePay®, or other third party funding types. The method 260 also include submitting payment after entering payment type information in a submit payment step 292. The method 260 also include sending payment confirmation in a send payment confirmation step 294 followed by an exit step 296.

The systems, apparatuses, interfaces, and/or applications and methods implementing them are set up for charging an annual fee, which may be paid yearly, semi-annually, or monthly. The systems, apparatuses, interfaces, and/or applications and methods implementing them are set up so that the user may view the amount in the one or more chosen funding options. The systems, apparatuses, interfaces, and/or applications and methods implementing them are set up to charge a fee for managing the funds in the funding options, wherein the fee will be a percentage of the value of the one or more funding options.

It should be recognized that the methods of FIGS. 2A and 2B may be configured for any user and any user specific persons.

### Stationary Devices

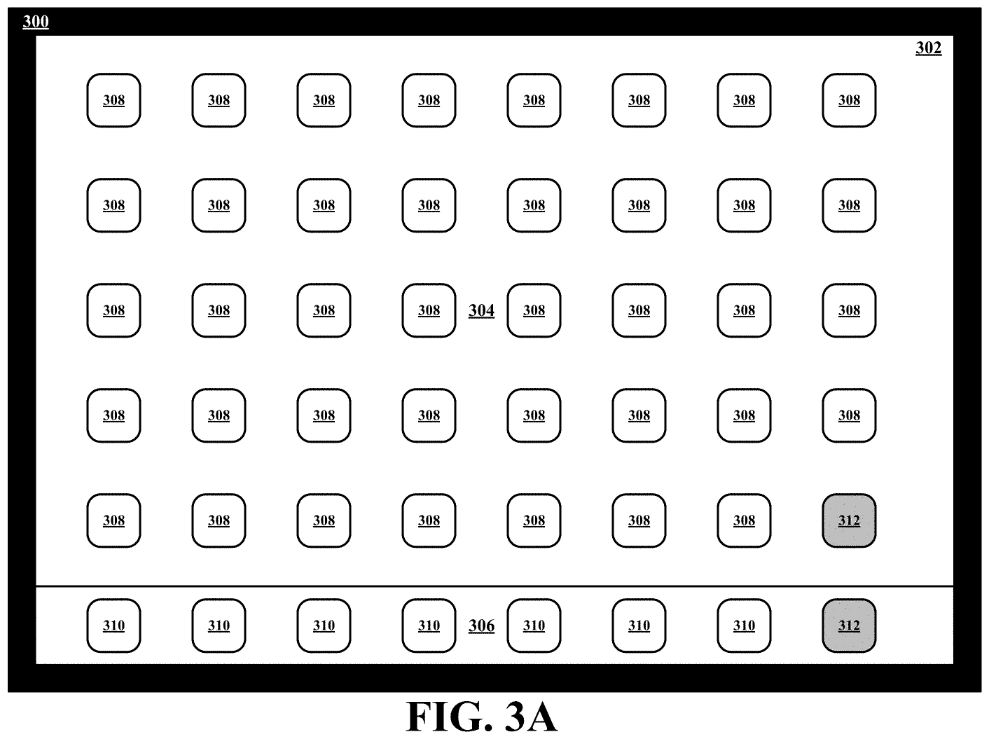

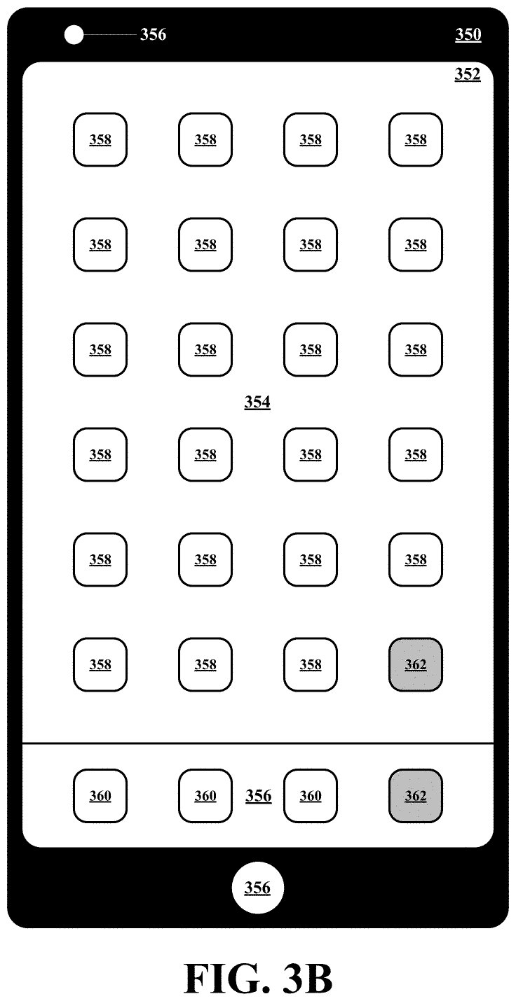

Referring now to FIG. 3A, an embodiment of a stationary device, generally 296, is shown to include a display 298. The display 302 includes two zone 300 and 302. The zone 304 includes icons 304 that are activated by double clicking, while the zone 306 includes single click activatable icons 306. The application of this disclosures is represented by the highlighted icons 308 in each of the zones 304 and 306, but of course the application icon 312 may be present only in one of the zones 304 or 306. Of course, many of the other components of the stationary device are not shown such as cameras, speakers, mouse or other pointer input devices, keyboards, microphones, etc.

### Mobile or Wearable Devices

Referring now to FIG. 3B, an embodiment of a mobile or wearable device, generally 350, is shown to include a display 352. The display 352 includes two zone 354 and 356. The zone 354 includes icons 358 that are activated by double clicking, while the zone 356 includes single click activatable icons 360. The application of this disclosures is represented by the highlighted icons 362 in each of the zones 354 and 356, but of course the application icon 312 may be present only in one of the zones 354 or 356. The display 352 also includes an ON button 364 and a front facing camera 366. Of course, many of the other components of the mobile device are not shown such as speakers, microphones, etc.

### Screen Sequence Depicting Parent and Child Data Entry

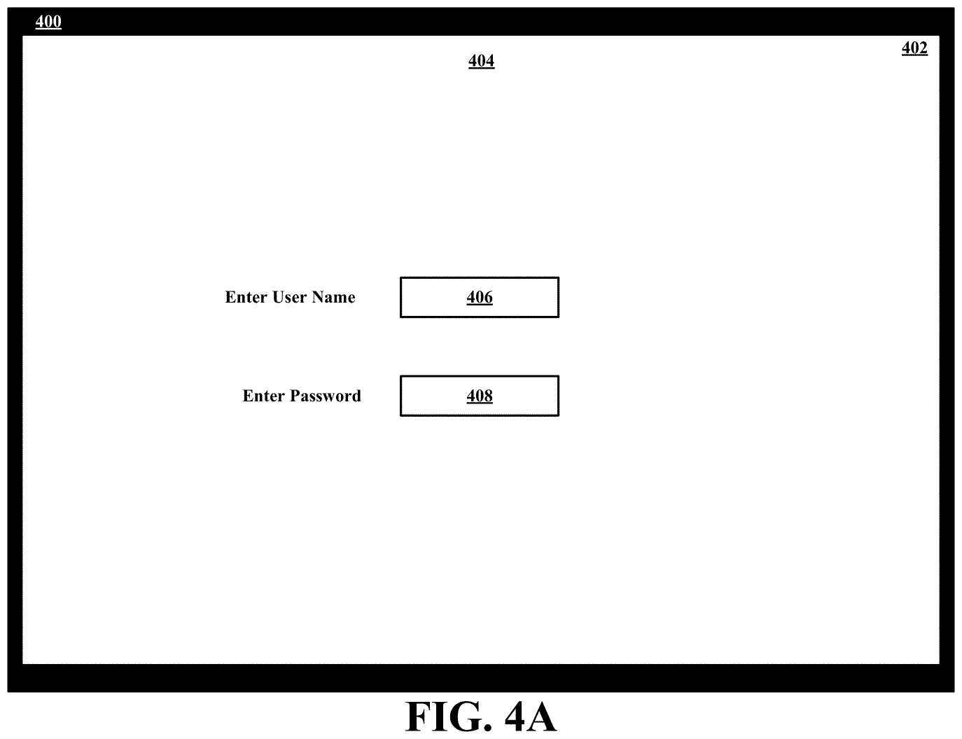

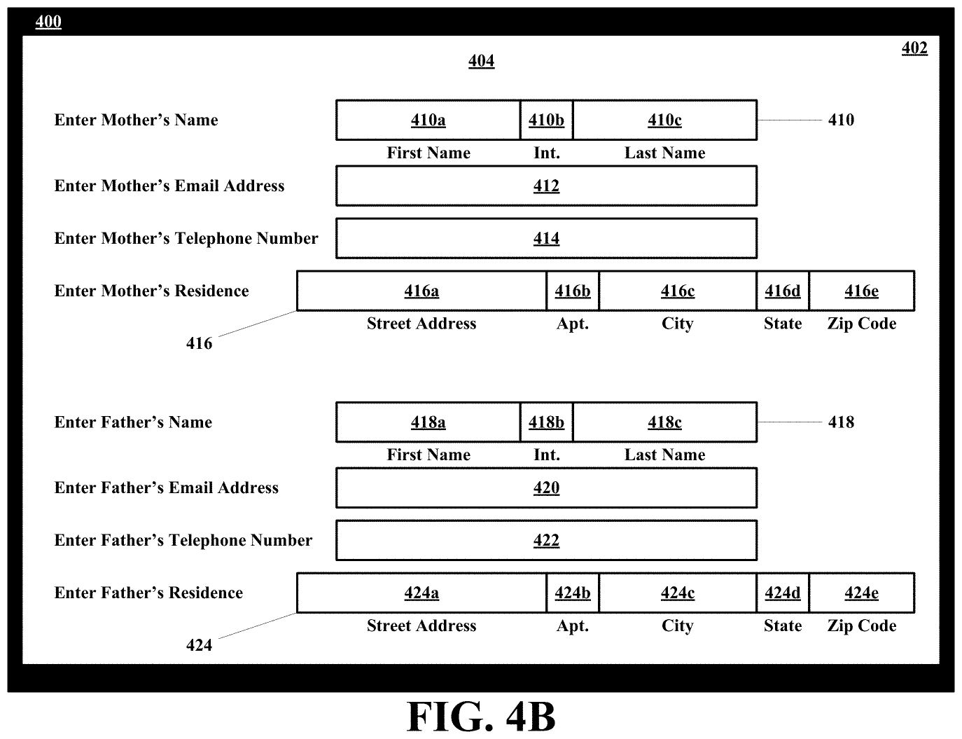

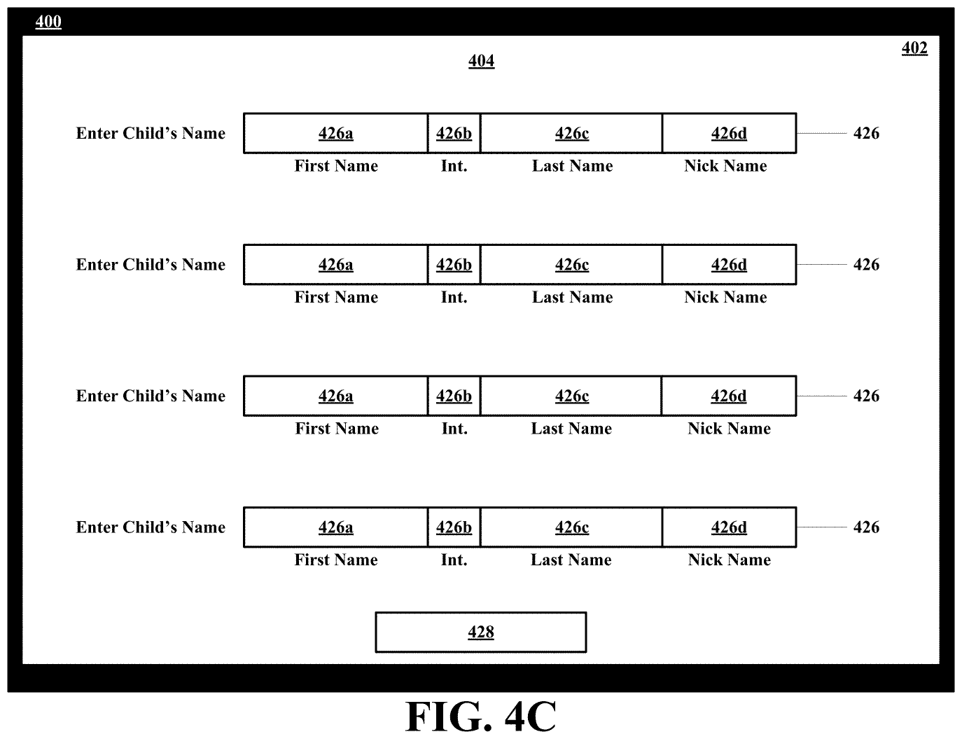

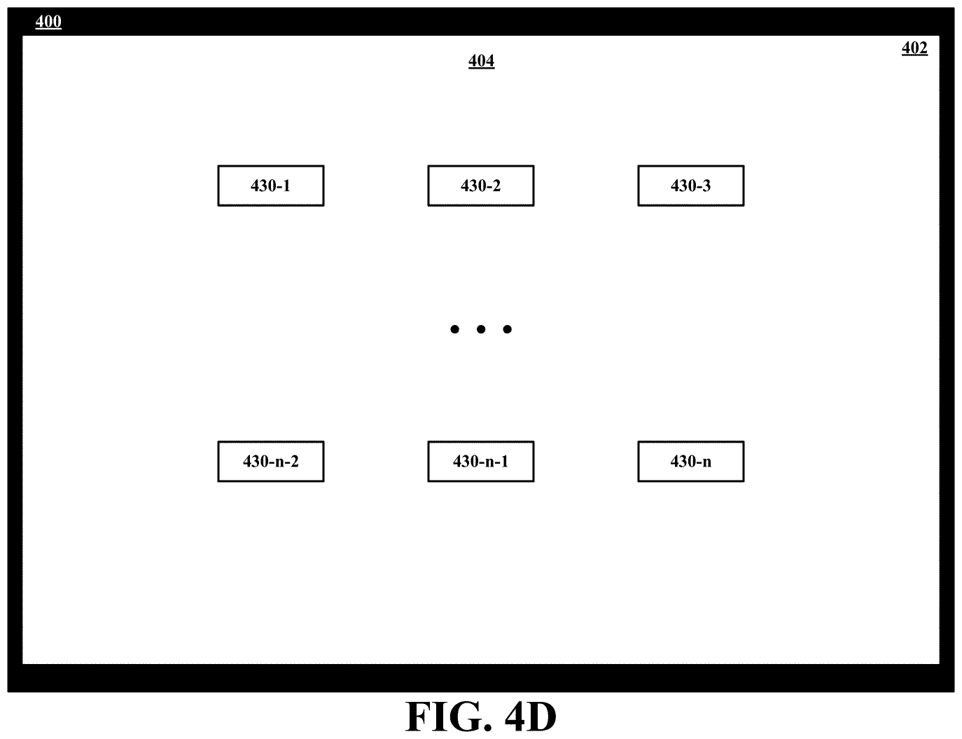

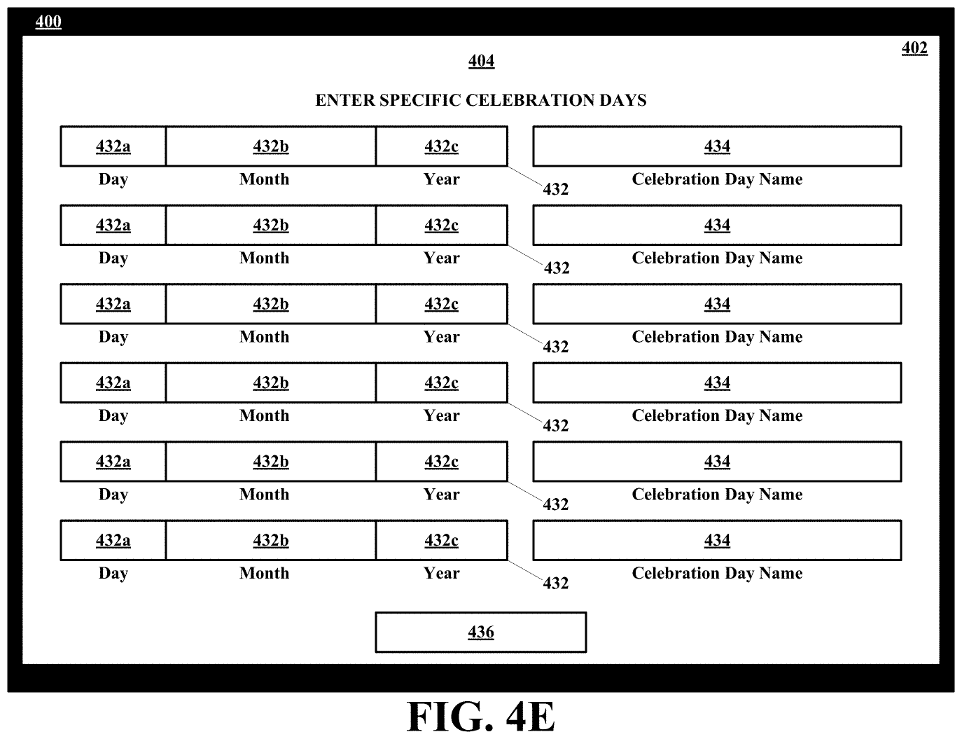

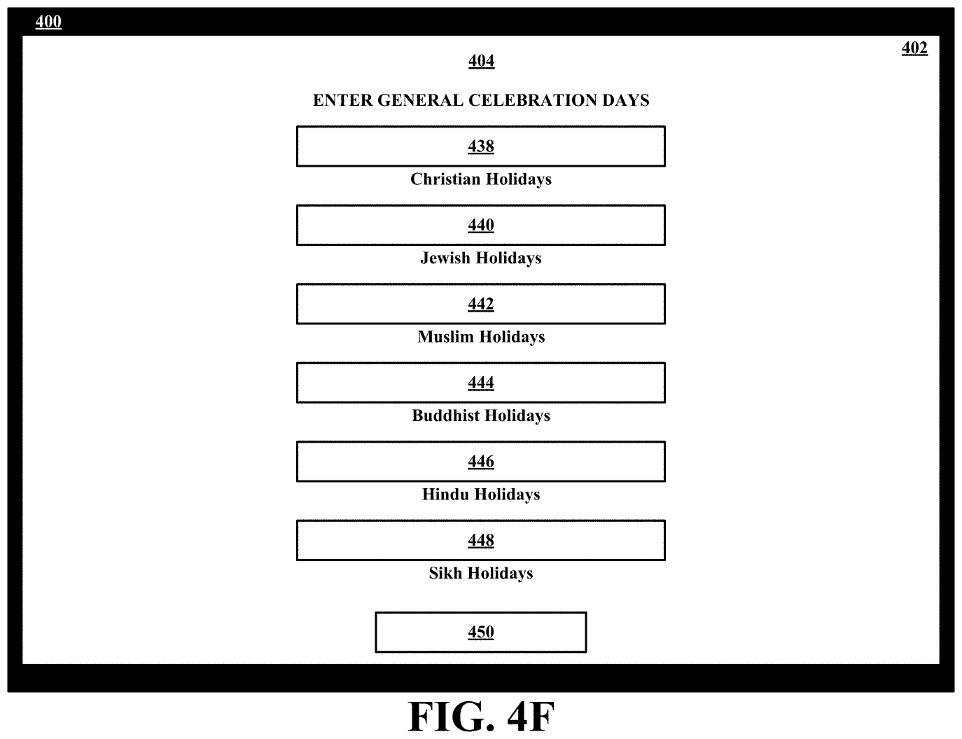

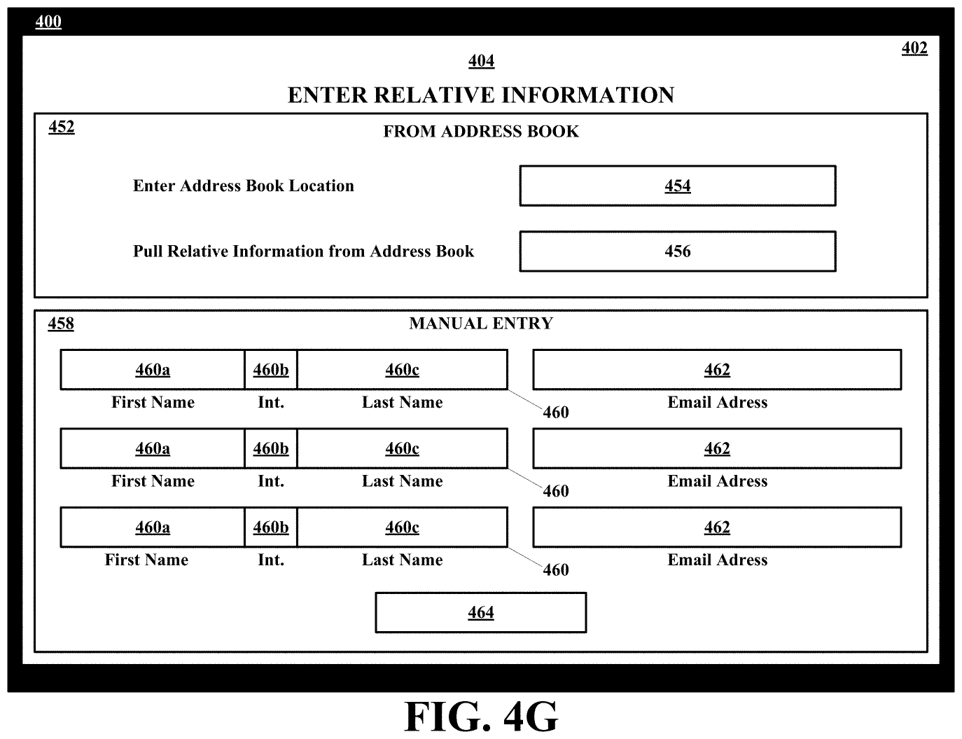

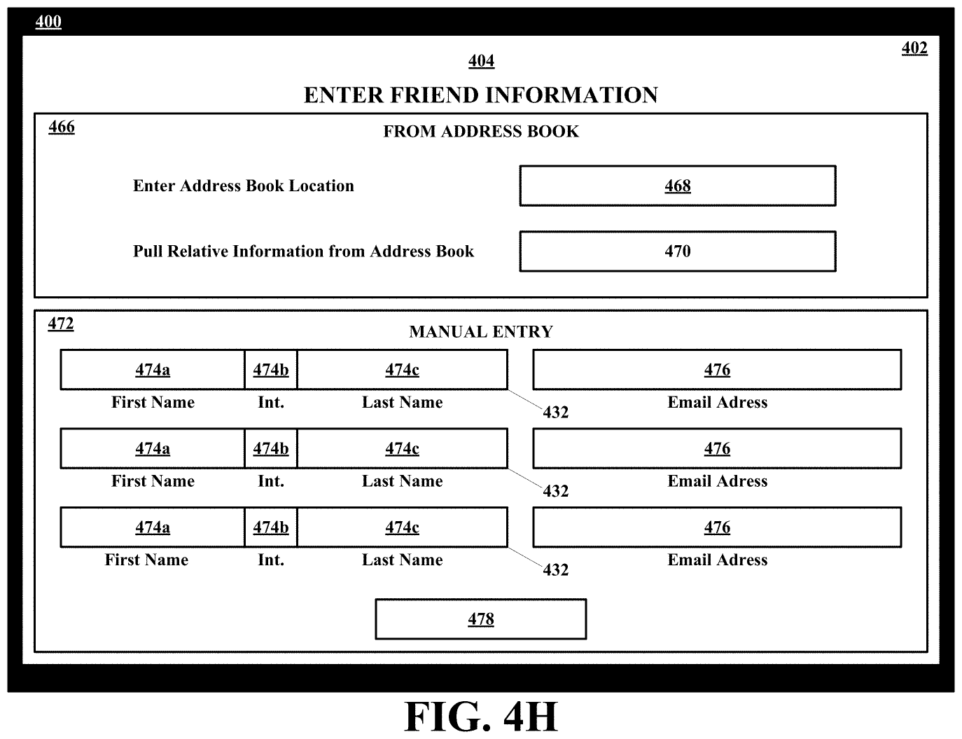

Referring now to FIGS. 4A-H, these figures depict a screen sequence for data entry after activating the application on a stationary, mobile or wearable device, assuming that the application has already been installed on the device and this is the first time the user has accessed the application. It should be recognized that the screen sequence FIGS. 4A-G may be configured for any user and any user specific persons.

Looking at FIG. 4A, a device, generally 400, is shown to include a display 402 having an active window area 404. The window 404 includes an enter user name box 406 and a enter password box 408. When entering the user name and password, the systems, apparatuses, and/or interfaces may suggest a user name and a password or give indications of the relative strength of either the user name and/or password and may also supply information on length and acceptable characters and symbols and whether the user name and/or password must contain at least one of each type of characters as is well known in the art. While no submit box is shown in any of these screen shots, it is assumed that striking the enter key will result in submission of the data, but each screen may also include a submit box (not shown).

Looking at FIG. 4B, the window 404 is now shown to include parent entry boxes. Specifically, the window 404 now includes an enter mother's name box 410 having a first name entry location 410a, an initial entry location 410b, and a last name entry location 410c. The window 404 also now includes an enter mother's email address box 412 and an enter mother's phone number box 414. The window 404 now also includes an enter mother's residence box 416 including a street address entry location 416a, an apartment number entry location 416b, a city entry location 416c, a state entry location 416d, and a zip code entry location 416e. Again, while no submit box is shown in any of these screen shots, it is assumed that enter will result in submission of the data, but each screen may include a submit box (not shown).

The window 404 now also includes an enter father's name box 418 having a first name entry location 418a, an initial entry location 418b, and a last name entry location 418c. The window 404 also includes an enter father's email address box 420 and an enter father's phone number box 422. The window 404 also includes an enter father's residence box 424 including a street address entry location 424a, an apartment number entry location 424b, a city entry location 424c, a state entry location 424d, and a zip code entry location 424e. Of course, if the residence is the same, the entering “same in” the street address location will populate the mother's residency information in the father's residence box. Again, while no submit box is shown in any of these screen shots, it is assumed that striking the enter key will result in submission of the data, but each screen may include a submit box (not shown).

Looking at FIG. 4C, the window 404 is now shown to include child entry boxes. Specifically, the window 404 now includes enter child's name boxes 426 including a first name entry location 426a, a middle initial entry location 426b, a last name entry location 426c and a nick name entry location 426d. The window 404 now also includes a more children box 428, which if activated will bring up more enter child boxes 426. Again, while no submit box is shown in any of these screen shots, it is assumed that striking the enter key will result in submission of the data, but each screen may include a submit box (not shown). For security purposes, the children name information may not be viewable except by the parents or other authorized persons that the parent identify to the application. The notification routines only send a website link and a child specific code, which includes no information about the child, parents, or other friends and relatives so even if received by some other person, the only information that the other person will have is the website link and the child specific code, which will not provide access to any information entered into the systems, apparatuses, interfaces, and/or applications.

### Screen Sequence Depicting Celebration Day Data Entry

Looking at FIG. 4D, the window 404 is now shown to include child boxes 430-1 through 430-n. The user may select each child box 430 so that the user may enter specific celebration day data for each child. In an alternate embodiment, the method may be configured so that when the parent enters in a child name and nick name, the method will jump to the relative and friend entry screens described above. Once the user selects a given child box 430, the systems, apparatuses, interfaces, and/or applications proceed to FIG. 4E, where the window 404 is now shown to include specific celebration day date boxes 432 including a day entry location 432a, a month entry location 432b, and a year entry location 432c, specific celebration day name 434, and a more specific celebration day box 436. The systems, apparatuses, interfaces, and/or applications then proceeds to FIG. 4F, where the window 404 is now shown to include holiday celebration days type boxes 438 through 448, and a more holiday celebration days box 450. The box 438, if selected, populates the general celebration days with appropriate Christian Holidays. The box 440, if selected, populates the general celebration days with appropriate Jewish Holidays. The box 442, if selected, populates the general celebration days with appropriate Muslim Holidays. The box 444, if selected, populates the general celebration days with appropriate Buddhist Holidays. The box 446, if selected, populates the general celebration days with appropriate Hindu Holidays. The box 438, if selected, populates the general celebration days with appropriate Sikh Holidays. The more box 450 allows the user to enter in specific alternate general holidays dates, generally just a day and month or a type such as Chinese New Year, which falls on different days for each or Thanksgiving, which occurs on a designated Thursday. In all of the date boxes, the boxes may include drop down windows for selecting day, months and years.

### Screen Sequence Depicting Relative and Friend Data Entry

Looking at FIG. 4G, the window 404 is now an ENTER RELATIVE INFORMATION screen including an address book entry portion 452 including an enter address book location box 454 and a pull relative information from the address book box 456. The boxes 454 and 456 are designed to permit the user to set up address book on the user's computer or computing device and direct the application to pull information from the indicated address book such as an Outlook address book or similar electronic address book.

The window 404 also includes a manual entry portion 458 including an enter relative name box 460 including a first name entry location 460a, a middle initial entry location 460b, and a last name entry location 460c, an email address box 462, and a more box 464, which if selected pulls up additional enter relative boxes 460.

Looking at FIG. 4H, the window 404 is now an ENTER FRIEND INFORMATION screen including an address book entry portion 466 including an enter address book location box 468 and a pull relative information from the address book box 470. The boxes 468 and 470 are designed to permit the user to set up an address box on a computer or computing device and direct the application to pull information from the address book such as an Outlook address book or similar electronic address book.

The window 404 also includes a manual entry portion 472 including an enter relative name box 474 including a first name location 474a, a middle initial location 474b, and a last name location 474c, an email address box 476, and a more box 478, which if selected pulls up additional enter relative boxes 474.

### Screen Sequence Depicting Funding Option Selection and Data Entry

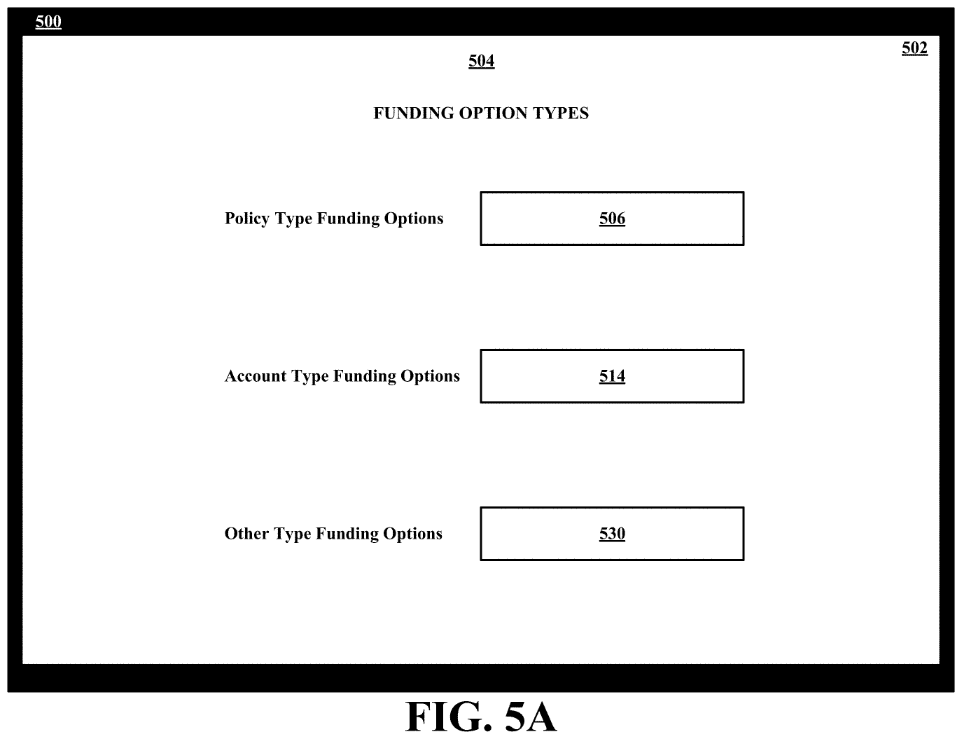

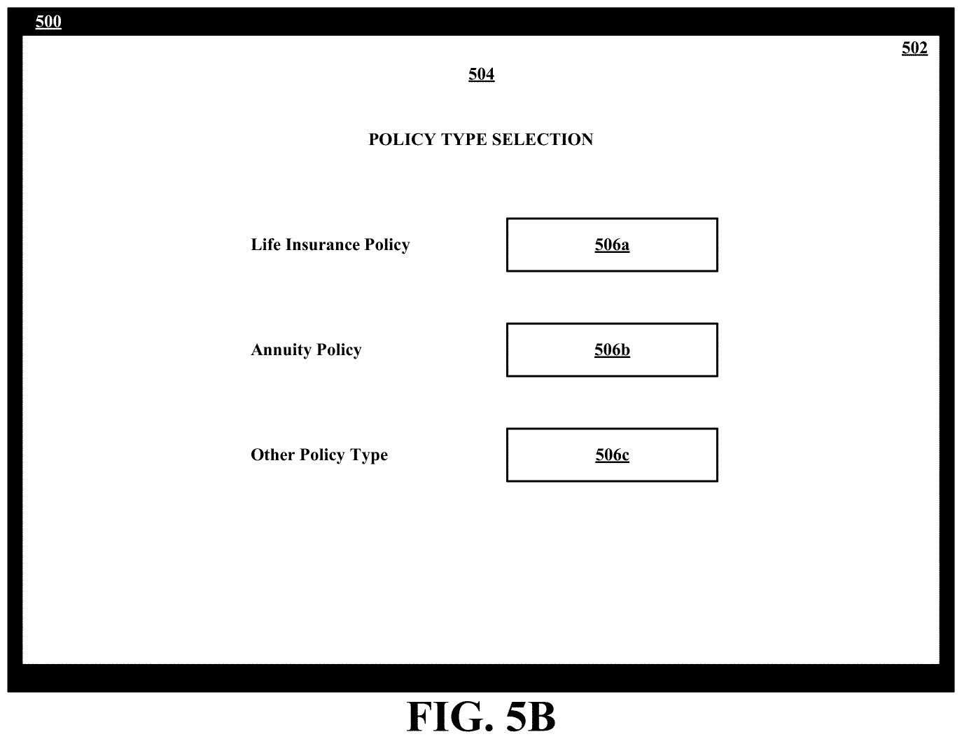

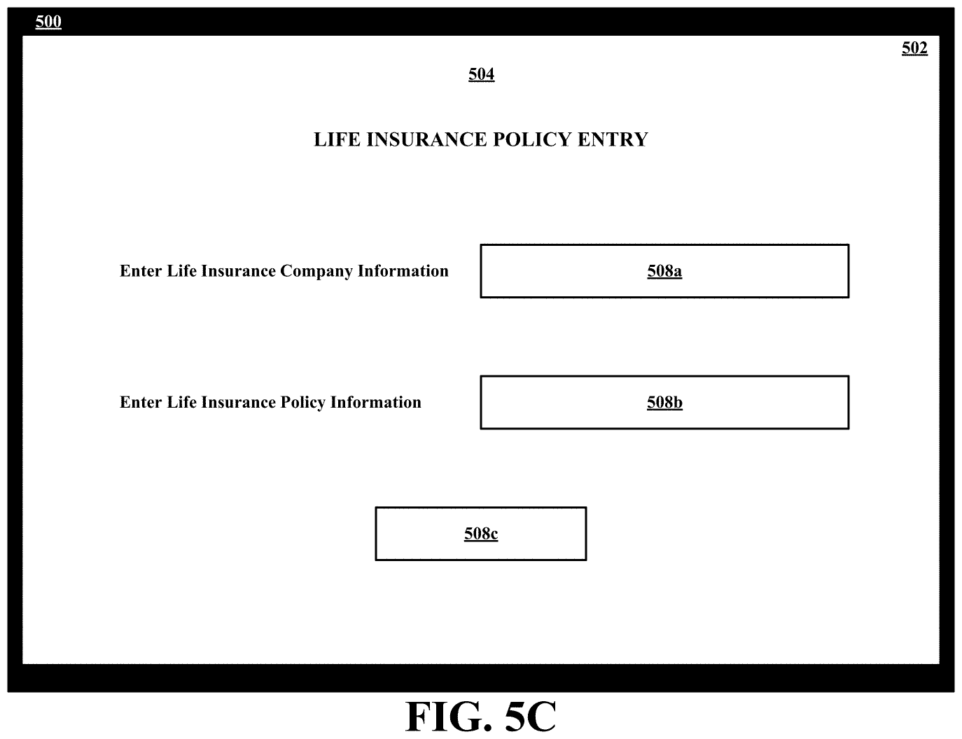

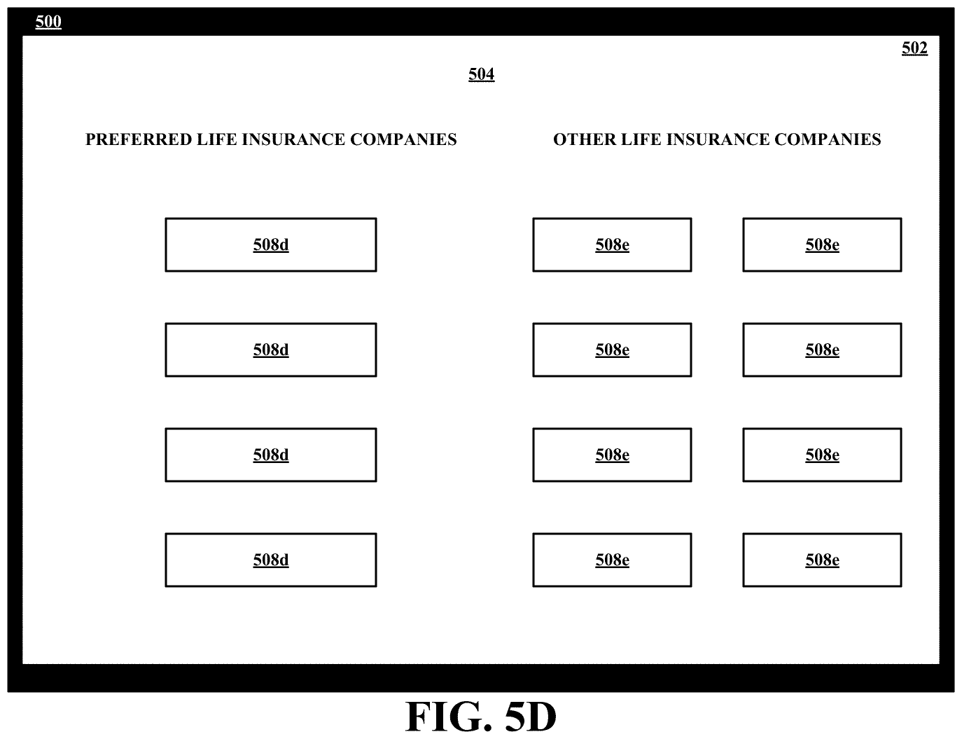

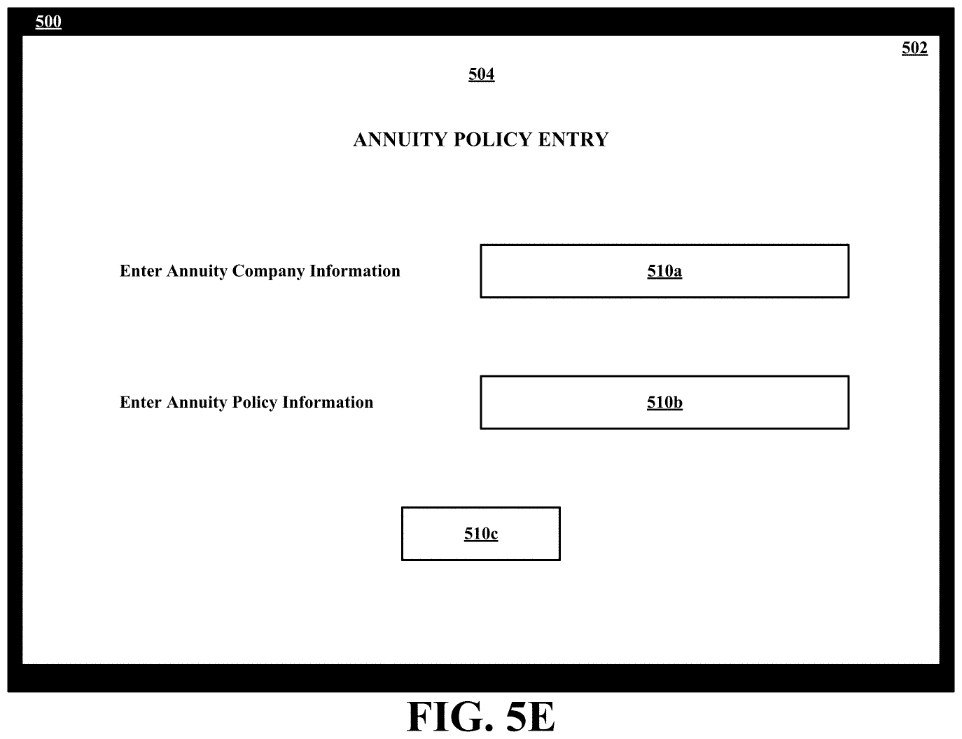

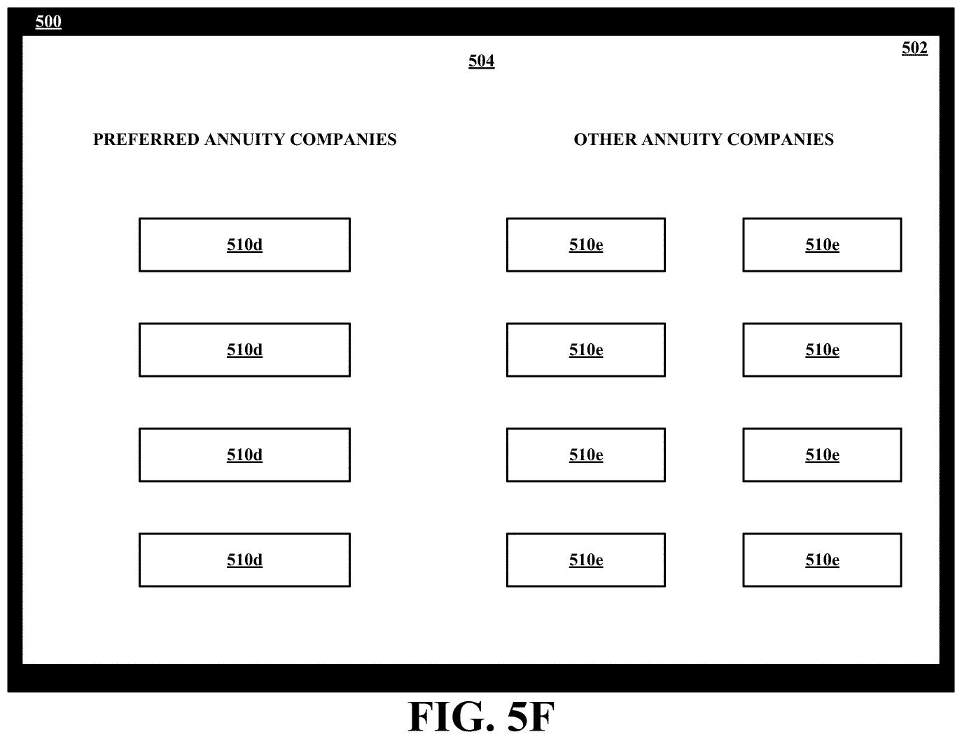

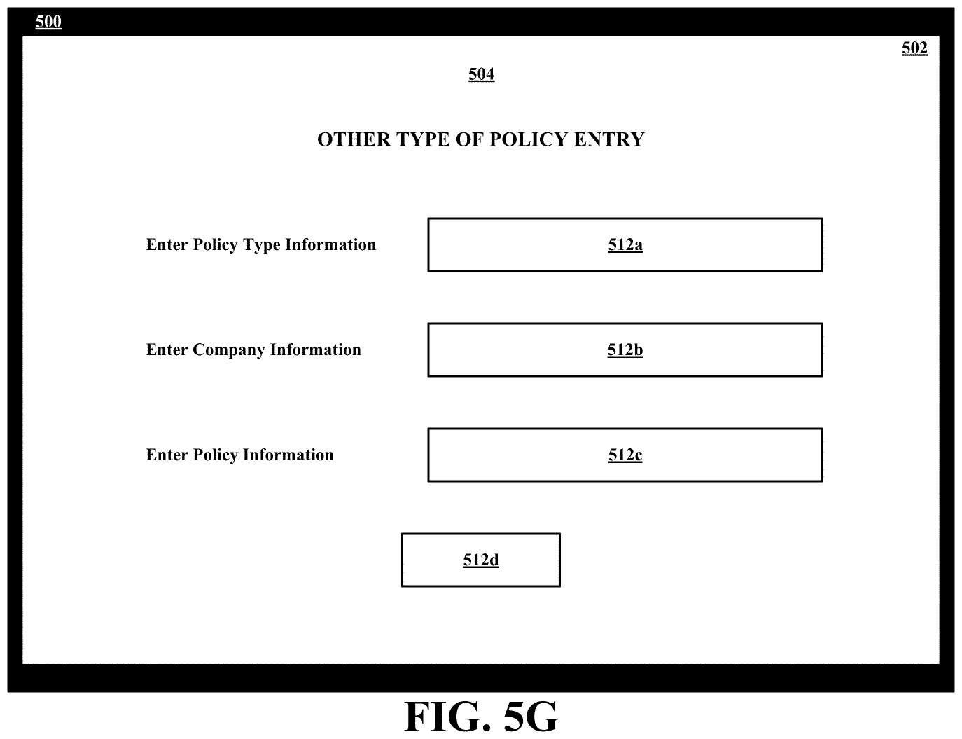

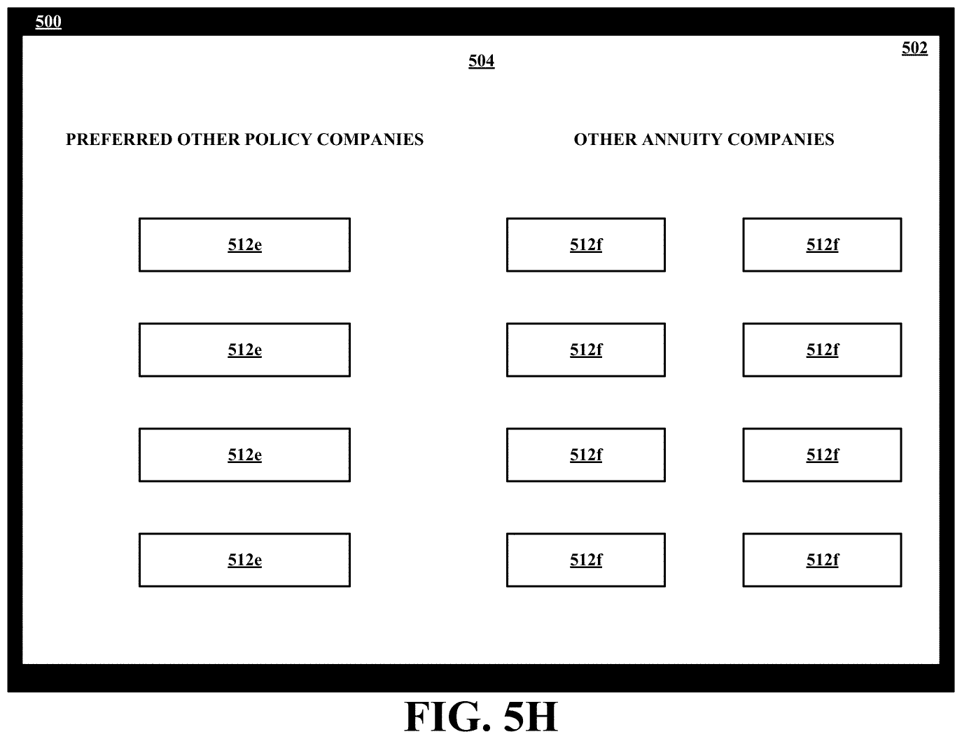

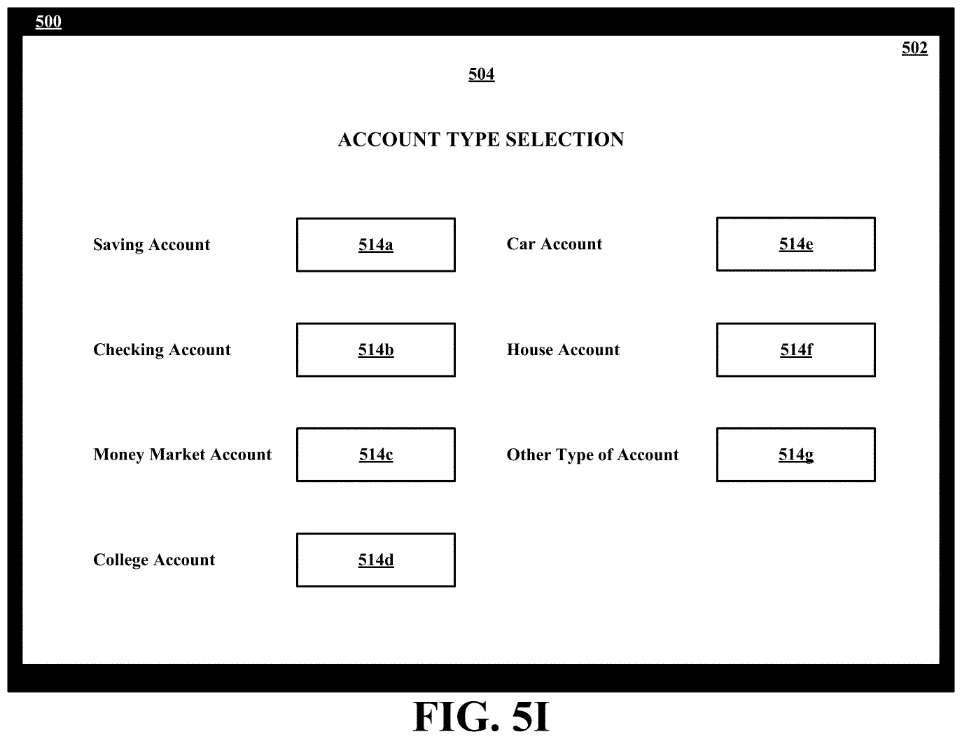

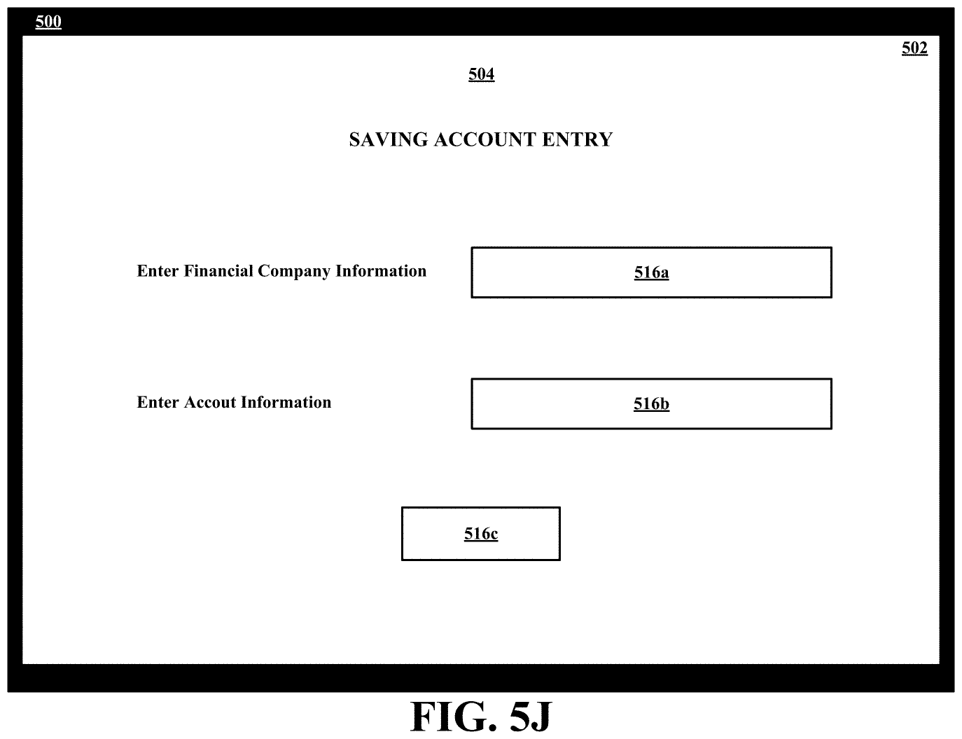

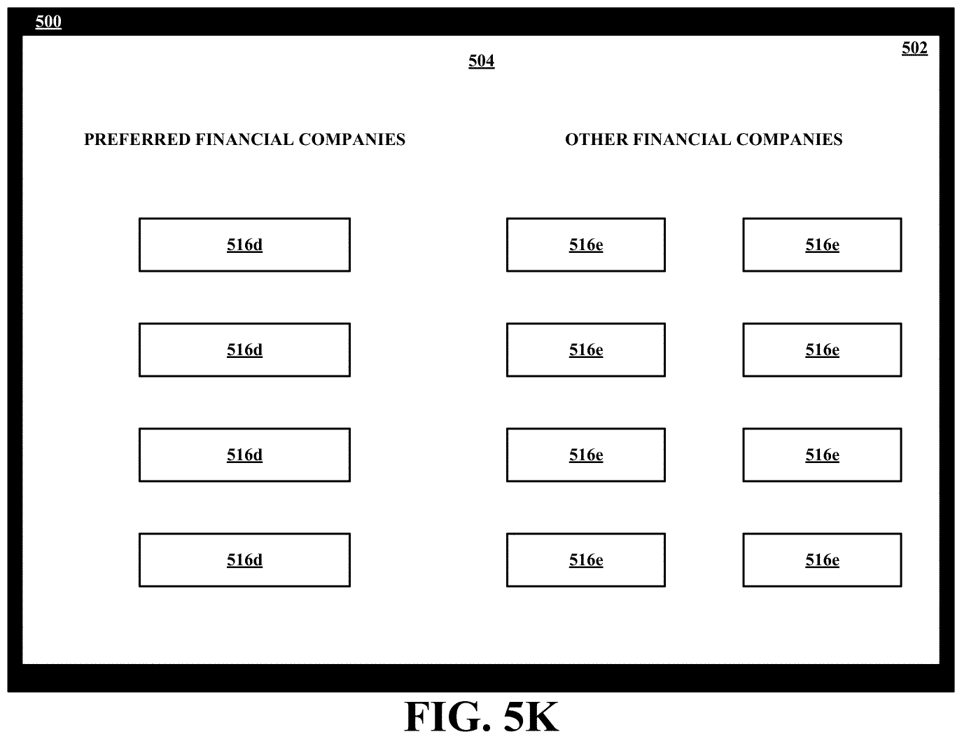

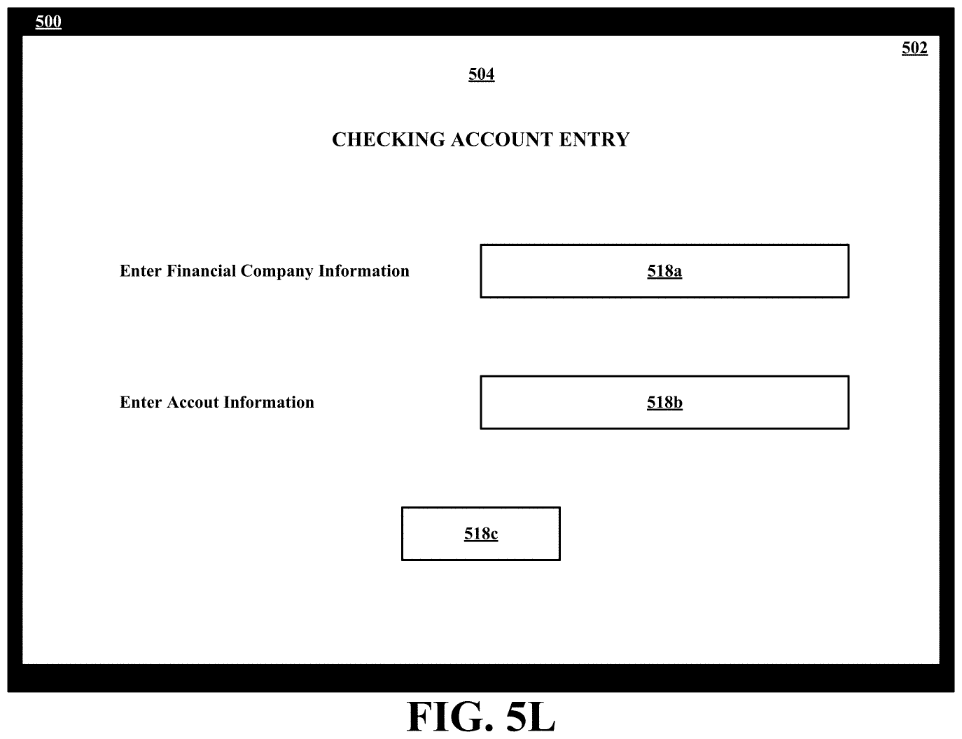

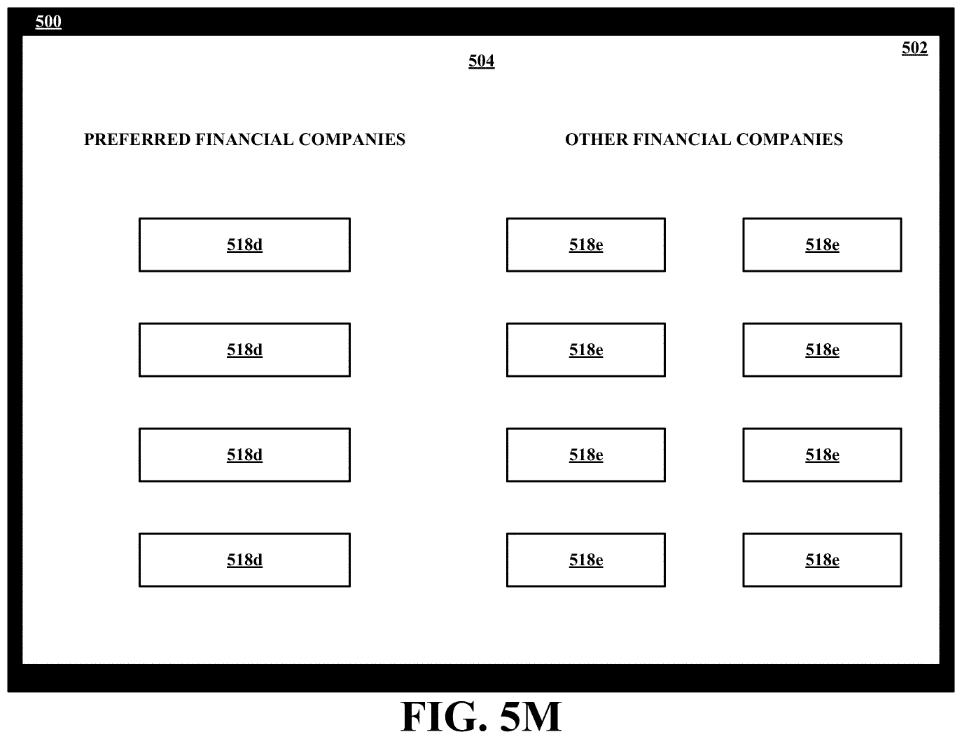

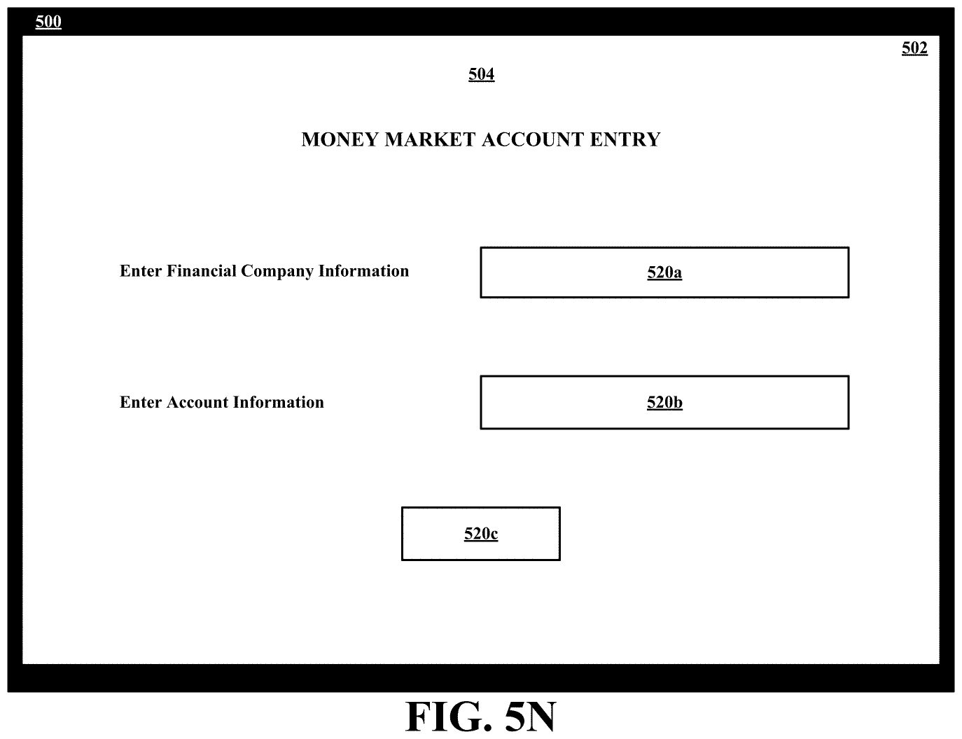

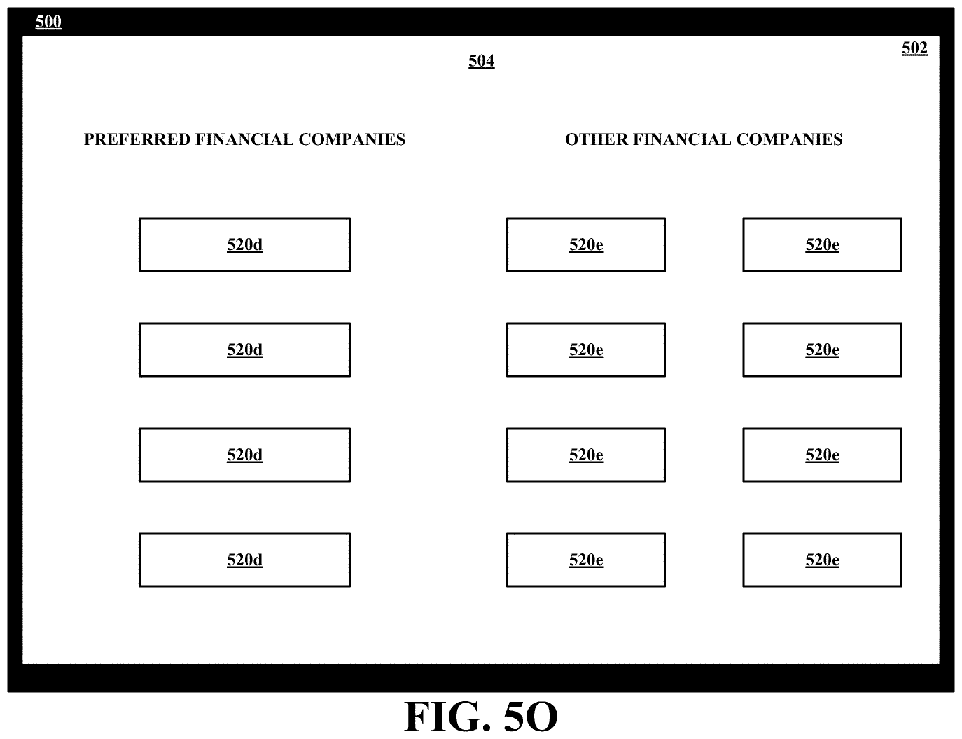

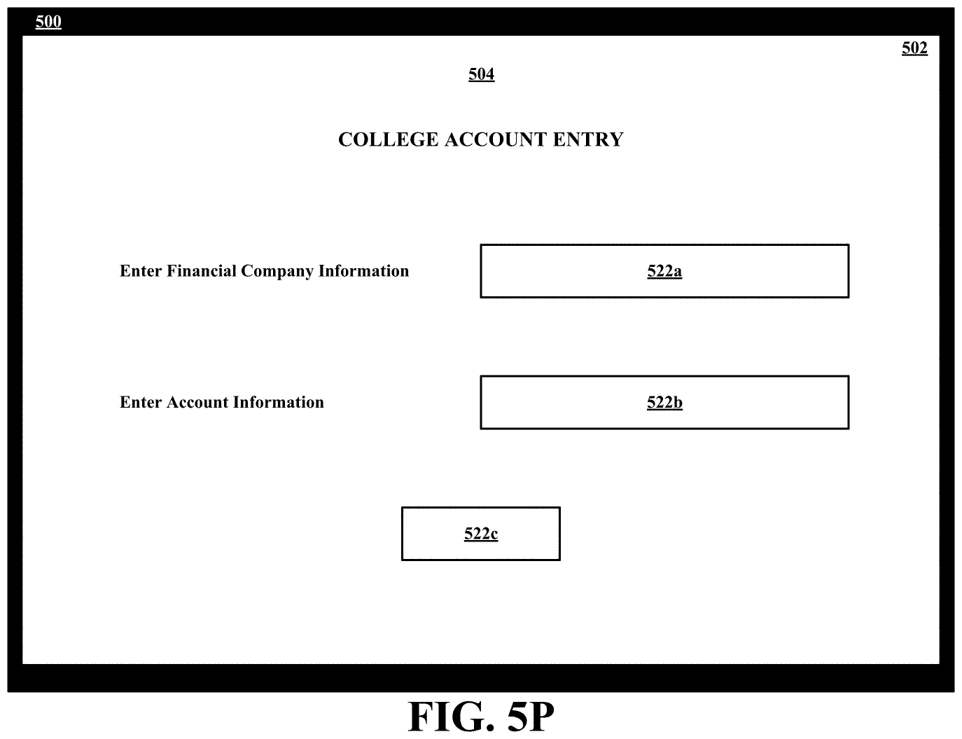

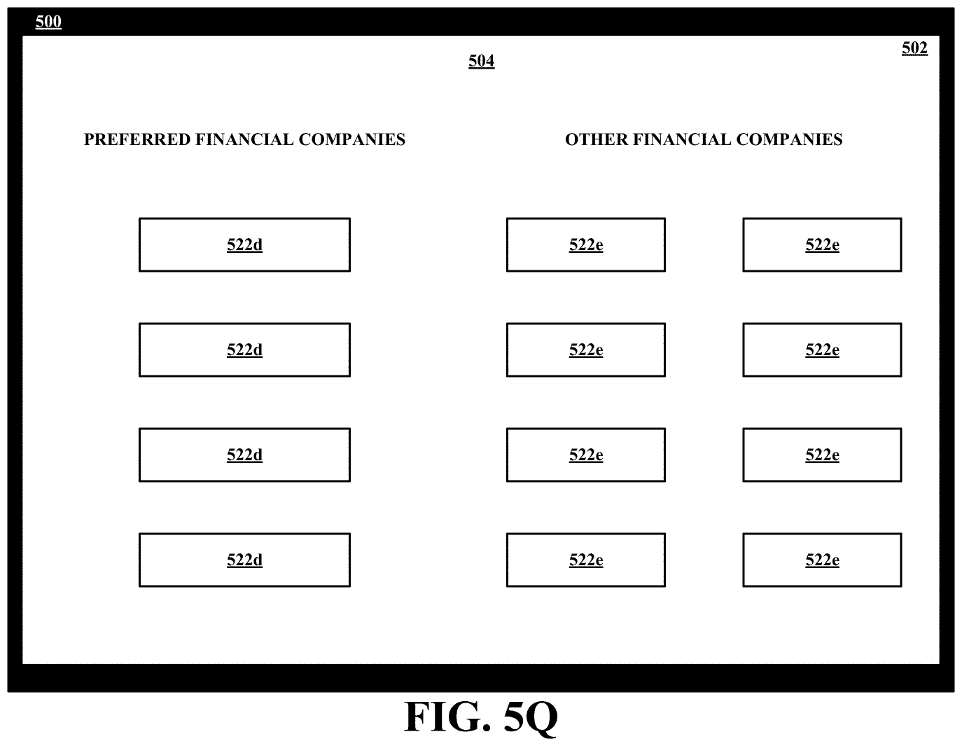

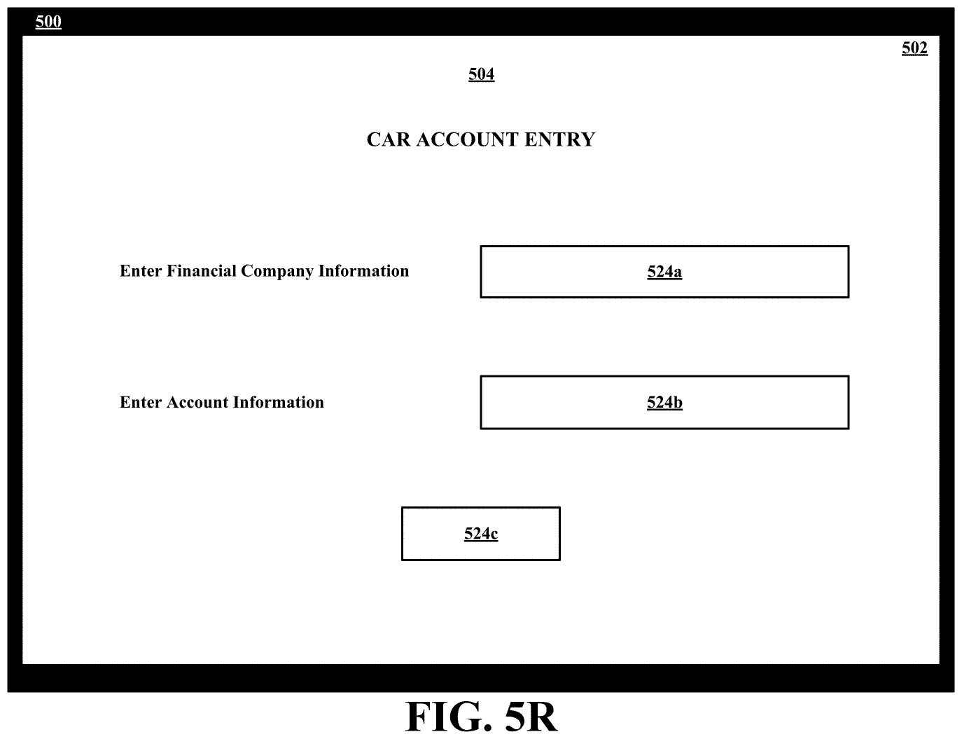

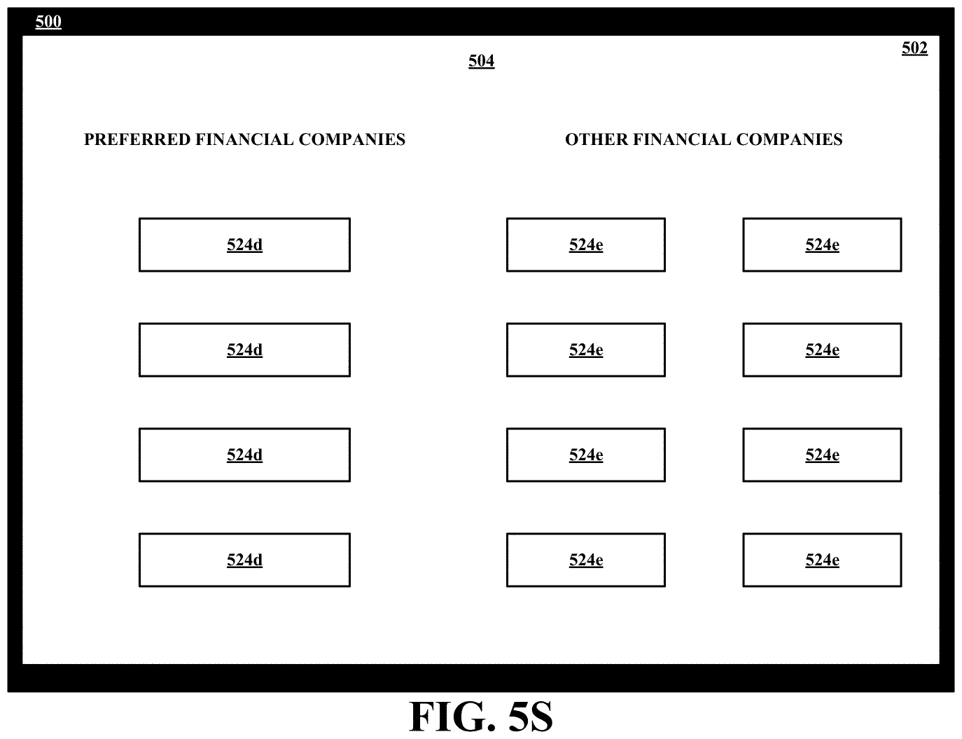

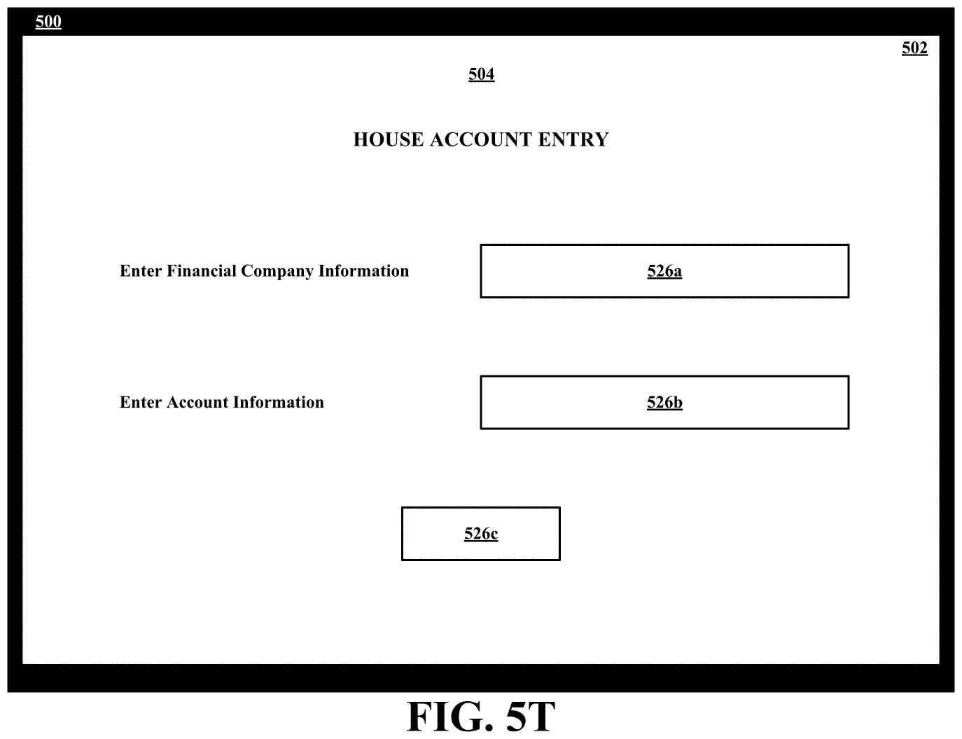

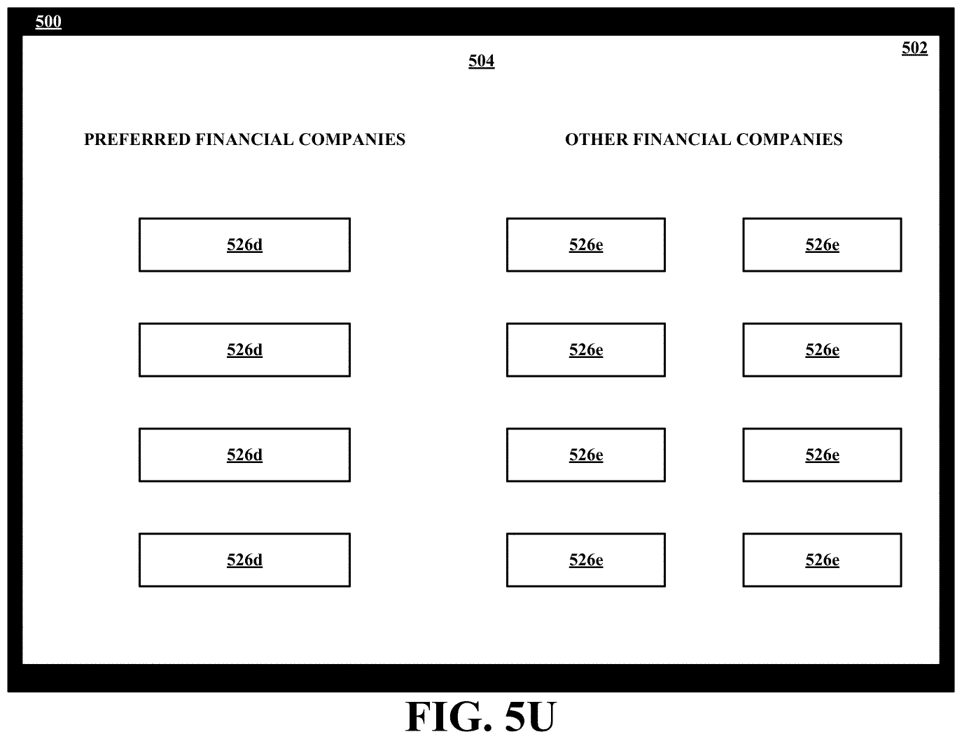

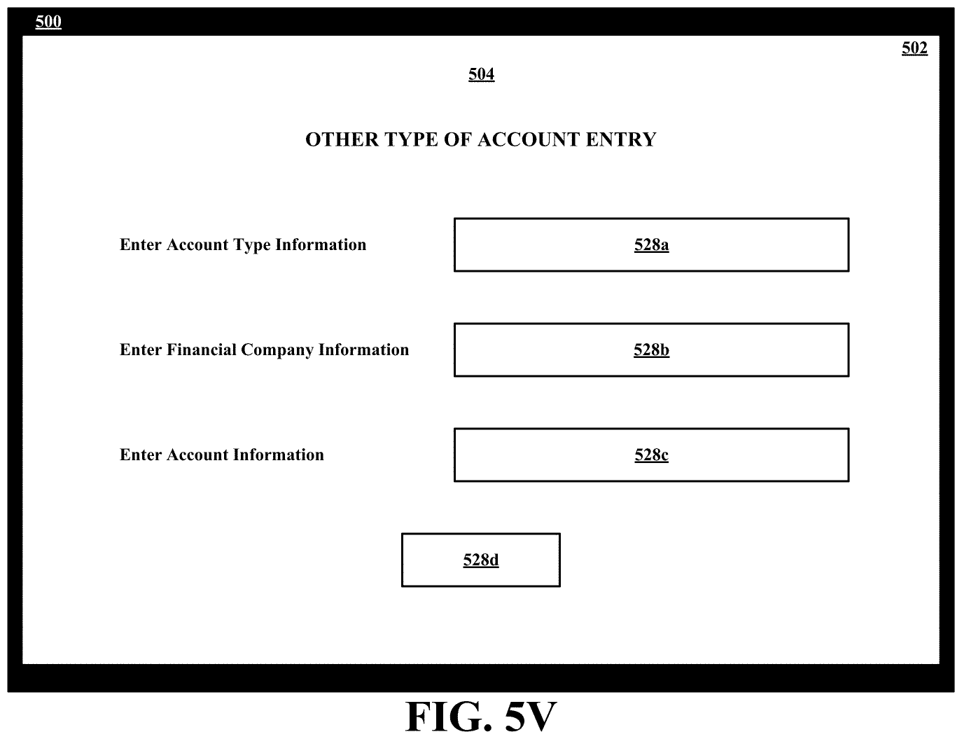

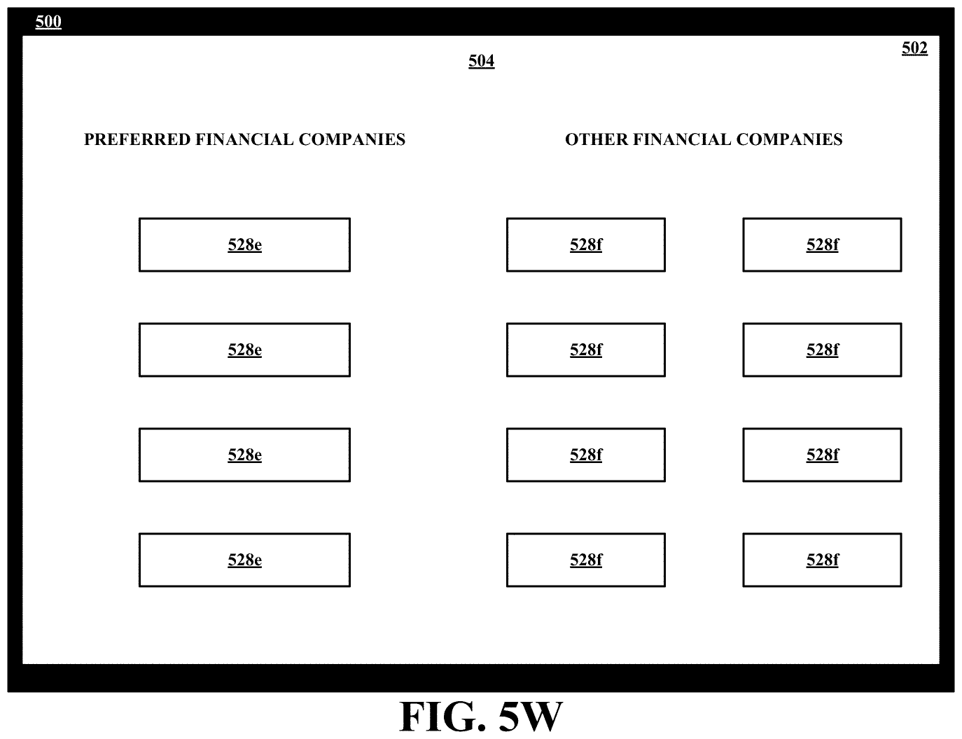

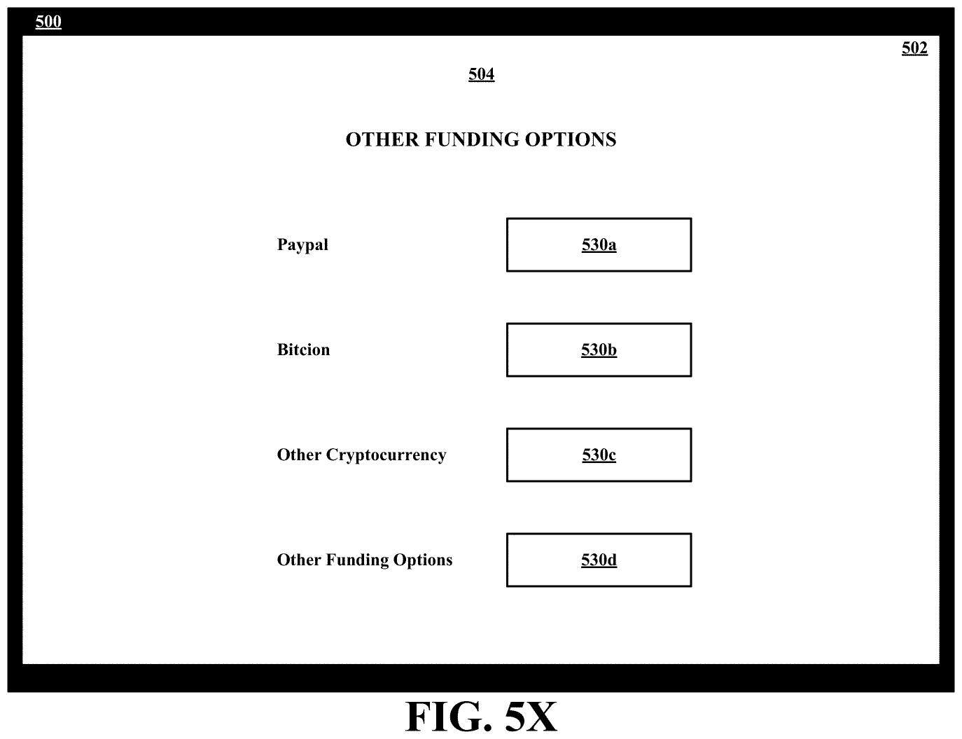

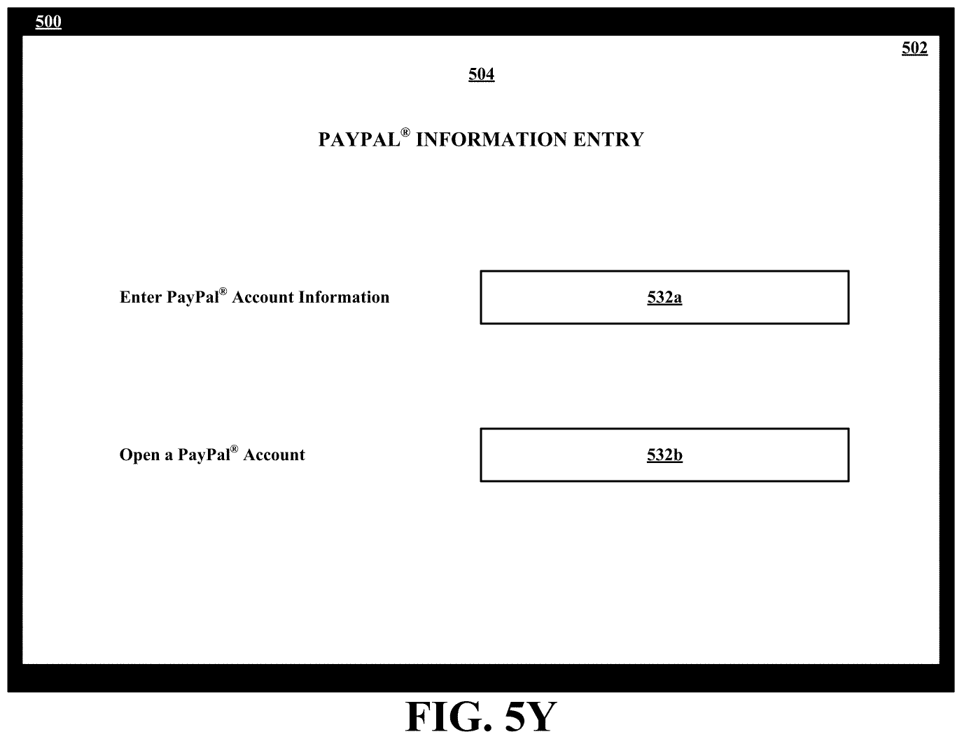

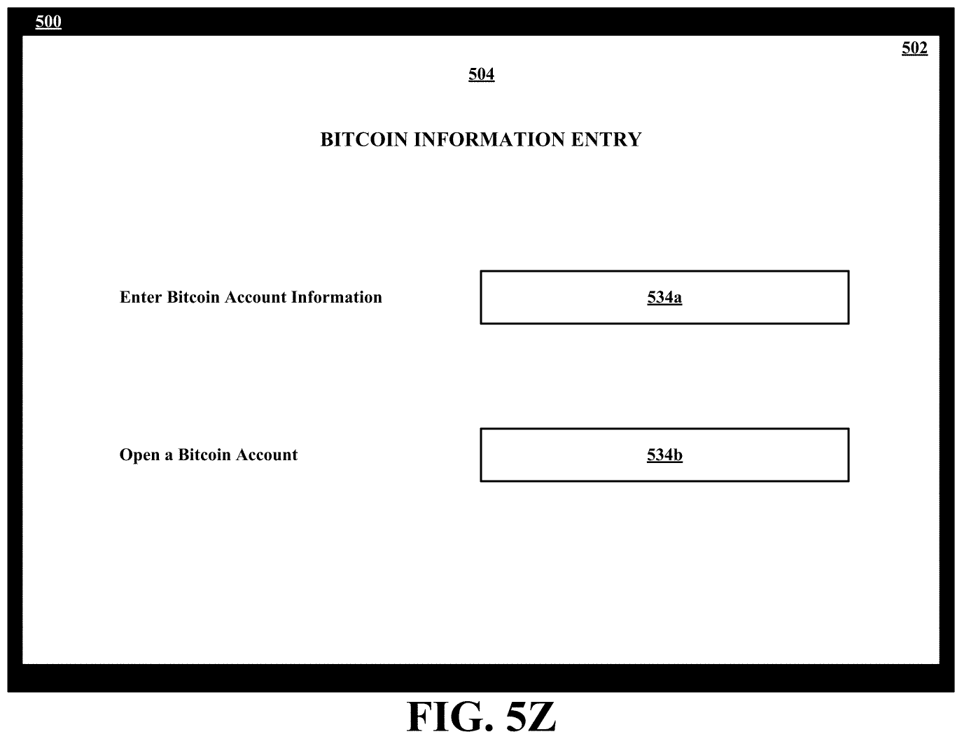

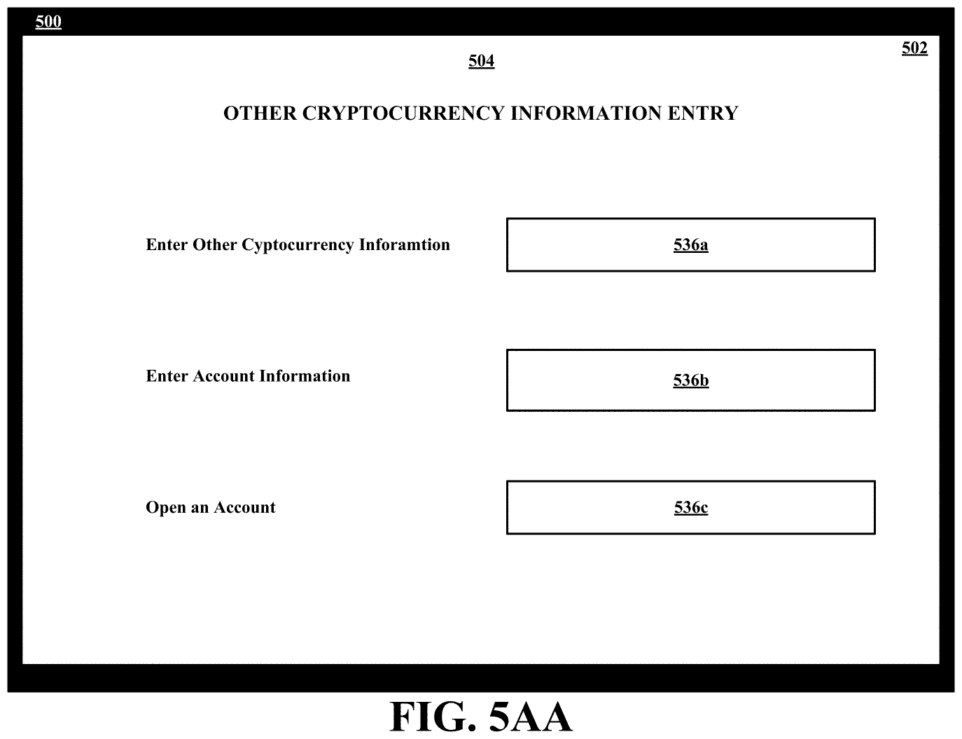

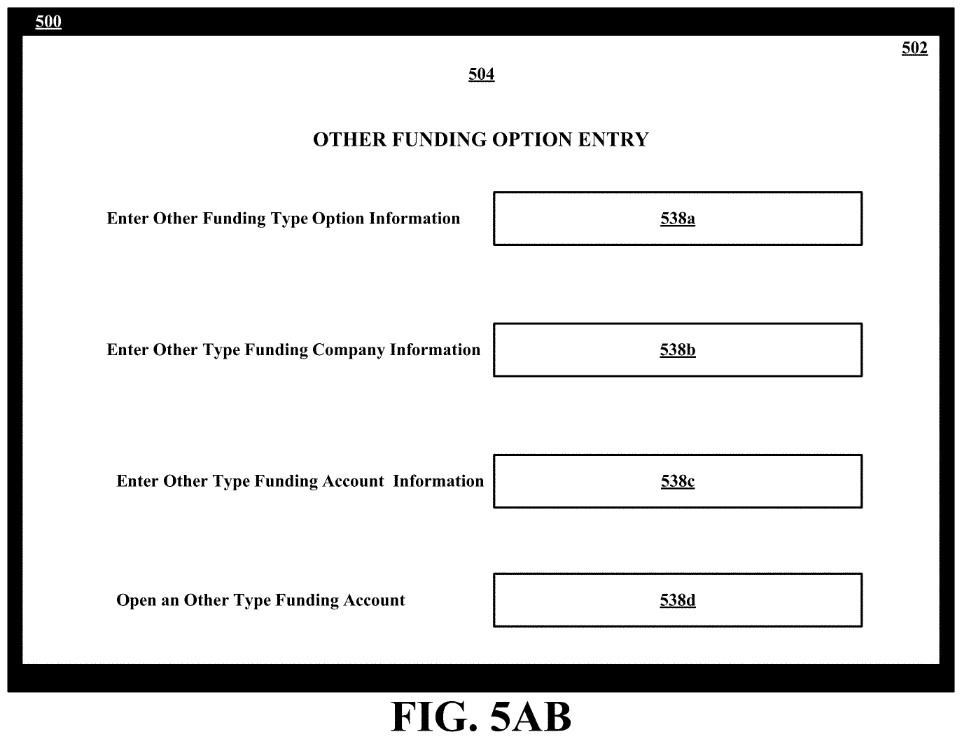

Referring now to FIGS. 5A-AB, these figures depict a screen sequence for selecting funding options and data entry concerning the funding options. Looking at FIG. 5A, the device, now generally 500, is shown to include a display 502 having an active window area 504. The window 504 includes a policy type funding options box 506, an account type funding options box 514, and other funding options box 530. It should be recognized that the screen sequence FIGS. 5A-G may be configured for any user and any user specific persons.

### Policy Type Funding Options

Looking at FIG. 5B, if the user selected the policy funding options box 506, then the window 504 now includes a life insurance box 506a, an annuity box 506b, and an other policy box 506c.

Life Insurance

If the user selects the life insurance box 506a and already has a life insurance policy, then the window 504 would now include a life company information entry box 508a and a life insurance policy information box 508b as shown in FIG. 5C. Alternative, if the user has not set up a life insurance policy, then the window 504 of FIG. 5C would also includes an apply for a life insurance policy box 508c and if selected would take the user to FIG. 5D, which would include preferred life insurance company boxes 508d and other life insurance company boxes 508e. Selecting any one of the preferred life insurance company boxes 508d would result in the automatic issuance of a life insurance policy form the selected company and automatically transfer company and policy information to the boxes 508a&b. Selecting any one of the other life insurance company boxes 508e would transfer control out of the application to the selected company's website, where the user may apply for an insurance policy. Once a policy has been issued, then the user may return to the window 504 of FIG. 5C for entering relevant information in boxes 508a&b.

Annuity

If the user selects the annuity policy box 506b and already has an annuity policy, then the window 504 would now include an annuity company information entry box 510a and an annuity policy information box 510b as shown in FIG. 5E. Alternative, if the user has not set up an annuity policy, then the window 504 of FIG. 5E would also includes an apply for an annuity policy box 510c and if selected would take the user to FIG. 5F, which would include preferred annuity company boxes 510d and other annuity company boxes 510e. Selecting any one of the preferred annuity company boxes 510d would result in the automatic issuance of an annuity policy and transference of relevant information to the boxes 510a&b. Selecting any one of the other annuity company boxes 510e would transfer control out of the application to the selected company website, where the user may apply for an annuity policy. Once an annuity policy has been issued, then the user may return to the window 504 of FIG. 5E and enter relevant information in boxes 510a&b.

Other Policy Types

If the user selects the other policy box 506c and already has an other policy, then the window 504 would now include an other policy type information entry box 512a, an other policy type company information entry box 512b, and an other policy information entry box 512c as shown in FIG. 5G. Alternative, if the user has not set up such a policy, then the window 504 of FIG. 5G would also includes an apply for an other type policy box 512d and if selected would take the user to FIG. 5H, which would include preferred other type policy company boxes 512e and other type company boxes 512f. Selecting any one of the preferred other company boxes 512e would result in the automatic issuance of a policy and transference of relevant information to the boxes 512a-c. Selecting any one of the other type policy company boxes 512f would transfer control out of the application to the selected company site, where the user applies for an insurance policy at the selected company's website. Once a policy has been issued, then the user may return to the window 504 of FIG. 5G and enter relevant information in boxes 512a-c.

### Account Type Funding Options

Looking at FIG. 5I, if the user selected the account funding options box 514, then the window 504 now includes a saving account box 514a, a checking account box 514b, a money market account box 514c, a college account box 514d, a car account box 514e, a house account box 514f, and an other type of account box 514g.

Saving Account

If the user selects the saving account box 514a and already has a saving account, then the window 504 would now include a financial company information entry box 516a and a saving account information entry box as shown in FIG. 5J. Alternative, if the user has not set up a saving account, then the window 504 of FIG. 5J would also includes an open a saving account box 516c and if selected would take the user to FIG. 5K, which would include preferred financial company boxes 516d and other financial company boxes 516e. Selecting any one of the preferred financial company boxes 516d would result in the automatic opening a saving account and would transfer relevant information to the boxes 516a&b. Selecting any one of the other financial company boxes 516e would transfer control out of the application to the selected company website, where the user applies for a saving account. Once an account has been opened, then the user can return to the window 504 of FIG. 5J and enter relevant information in boxes 516a&b.

Checking Account

If the user selects the checking account box 514b and already has a checking account, then the window 504 would now include a financial company information entry box 518a and a checking account information entry box as shown in FIG. 5L. Alternative, if the user has not set up a checking account, then the window 504 of FIG. 5L would also includes open a checking account box 518c, and if selected would take the user to FIG. 5M, which would include preferred financial company boxes 518d and other financial company boxes 518e. Selecting any one of the preferred financial company boxes 518d would result in the automatic opening a checking account and transference of relevant information to the boxes 518a&b. Selecting any one of the other financial company boxes 518e would transfer control out of the application to the selected company website, where the user applies for a checking account. Once an account has been opened, then the user may return to the window 504 of FIG. 5L and enter relevant information in boxes 518a&b.

Money Market Account

If the user selects the money market account box 514c and already has a money market account, then the window 504 would now include a financial company information entry box 520a and a money market account information entry box 520b as shown in FIG. 5N. Alternative, if the user has not set up a money market account, then the window 504 of FIG. 5N would also includes open a money market account box 520c, and if selected would take the user to FIG. 5O, which would include preferred financial company boxes 520d and other financial company boxes 520e. Selecting any one of the preferred financial company boxes 520d would result in the automatic opening a money market account and transference of relevant information to the boxes 520a&b. Selecting any one of the other financial company boxes 520e would transfer control out of the application to the selected company website, where the user applies for a money market account. Once an account has been opened, then the user can return to the window 504 of FIG. 5N and enter relevant information in boxes 520a&b.

College Account

If the user selects the college account box 514d and already has a college account, then the window 504 would now include a financial company information entry box 522a and a college account information entry box 522b as shown in FIG. 5P. Alternative, if the user has not set up a college account, then the window 504 of FIG. 5P would also includes open a college account box 522c, and if selected would take the user to FIG. 5Q, which would include preferred financial company boxes 522d and other financial company boxes 522e. Selecting any one of the preferred financial company boxes 522d would result in the automatic opening a college account and transference of relevant information to the boxes 522a&b. Selecting any one of the other financial company boxes 522e would transfer control out of the application to the selected company website, where the user applies for a college account. Once an account has been opened, then the user can return to the window 504 of FIG. 5P and enter relevant information in boxes 522a&b.

Car Account

If the user selects the car account box 514e and already has a car account, then the window 504 would now include a financial company information entry box 524a and a car account information entry box 524b as shown in FIG. 5R. Alternative, if the user has not set up such car account, then the window 504 of FIG. 5R would also includes open a car account box 524c, and if selected would take the user to FIG. 5S, which would include preferred financial company boxes 524d and other financial company boxes 524e. Selecting any one of the preferred financial company boxes 524d would result in the automatic opening a car account and would transfer relevant information to the boxes 524a&b. Selecting any one of the other financial company boxes 524e would transfer control out of the application to the selected company website, where the user applies for a car account. Once an account has been opened, then the user can return to the window 504 of FIG. 5R and enter relevant information in boxes 524a&b.

House Account

If the user selects the house account box 514f and already has a house account, then the window 504 would now include a financial company information entry box 526a and a house account information entry box 526b as shown in FIG. 5T. Alternative, if the user has not set up a house account, then the window 504 of FIG. 5T would also includes open a house account box 526c, and if selected would take the user to FIG. 5U, which would include preferred financial company boxes 526d and other financial company boxes 526e. Selecting any one of the preferred financial company boxes 526d would result in the automatic opening a house account and would transfer relevant information to the boxes 526a&b. Selecting any one of the other financial company boxes 526e would transfer control out of the application to the selected company website, where the user applies for a house account. Once an account has been opened, then the user can return to the window 504 of FIG. 5T and enter relevant information in boxes 526a&b.

Other Type of Account

If the user selects the other type of account box 514g and already has an other type of account, then the window 504 would now include an other account type entry box 528a, a financial company information entry box 528b, and an enter other account information entry box 528c as shown in FIG. 5V. Alternative, if the user has not set up an other account type, then the window 504 of FIG. 5V would also includes an open an other account type box 528d, and if selected would take the user to FIG. 5W, which would include preferred financial company boxes 528e and other financial company boxes 528f. Selecting any one of the preferred financial company boxes 528e would result in the automatic opening an account and would transfer relevant information to the boxes 528b&c. Selecting any one of the other type financial company boxes 528f would transfer control out of the application to the selected company website, where the user applies for another type of account. Once an account has been opened, then the user can return to the window 504 of FIG. 5V and enter relevant information in boxes 528b&c.

### Other Type of Funding Options

Looking at FIG. 5X, if the user selected the other type funding options box 530, then the window 504 now includes a PayPal® box 530a, a Bitcoin box 530b, an other cryptocurrency box 530c, and other funding option box 530d.

PayPal® Entry

If the user selects the PayPal® box 530a and already has a PayPal® account, then the window 504 would now include a PayPal® account entry box 532a as shown in FIG. 5Y. Alternative, if the user has not set up a PayPal® account, then the window 504 would also include an open PayPal® account box 532b and if selected would transfer control out of the application to the PayPal® website, where the user may apply for a PayPal® account. Once a PayPal® account has been opened, then the user returns to the window 504 of FIG. 5Y for PayPal® account information entry.

Bitcoin Entry

If the user selects the Bitcoin box 530b, then the window 504 would now include a Bitcoin account entry box 534a as shown in FIG. 5Z. Alternative, if the user has not set up a Bitcoin account, then the window 504 would also includes an apply for a Bitcoin account box 534b and if selected would transfer control out of the application to the Bitcoin website, where the user may apply for a Bitcoin account. Once a Bitcoin account has been opened, then the user may return to the window 504 for Bitcoin account information entry.

Other Cryptocurrency Entry

If the user selects the other policy box 530c then the window 504 would now include an cryptocurrency company entry box 536a and an enter other cryptocurrency account information box 536b as shown in FIG. 5AA. Alternative, if the user has not set up such an other cryptocurrency account, then the window 504 would also include an apply for an other cryptocurrency account box 536c and if selected would transfer control out of the application to the cryptocurrency company website, where the user may open an other cryptocurrency account. Once an other cryptocurrency account has been opened, then the user may return to the window 504 for other cryptocurrency account information entry.

Other Funding Option

If the user selects the other funding option box 530d and already has an other funding type account, then the window 504 would now include an other funding type option entry box 538a, an other type funding company entry box 538b, and an other type funding account information box 538c as shown in FIG. 5AB. Alternative, if the user has not set up an other type funding account, then the window 504 would also include an apply for an other type funding account box 538b and if selected would transfer control out of the application to an other funding option company site, where the user can apply for an other funding type account. Once an other funding type account has been opened, then the user may return to the window 504 for other funding type account information entry.

Screen Sequence to Modify Entered Data and/or Add New Data

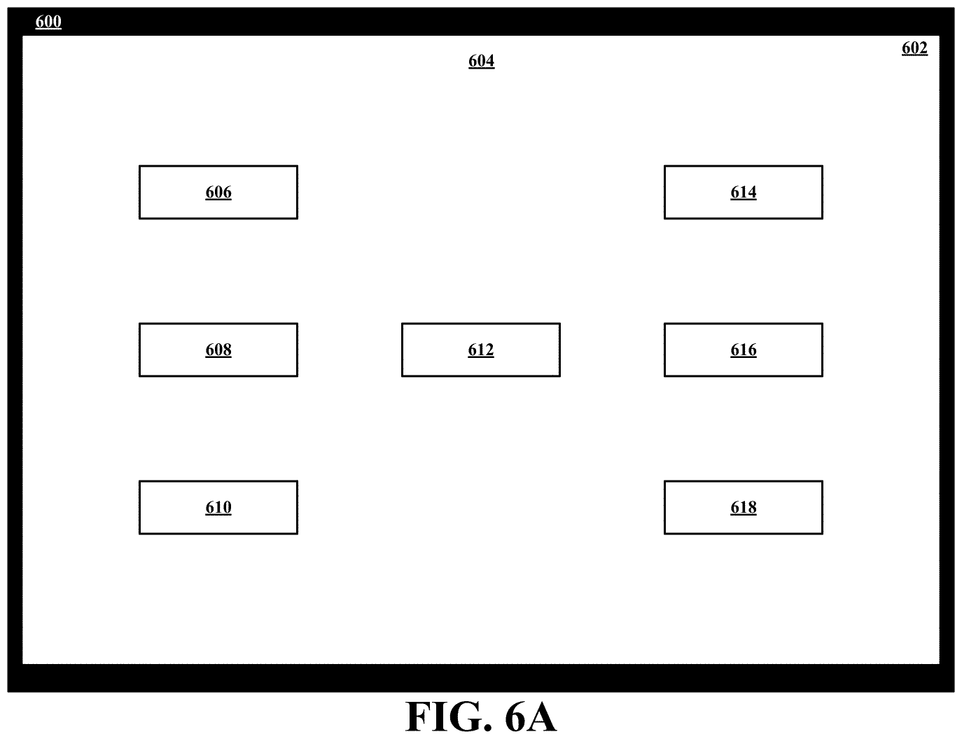

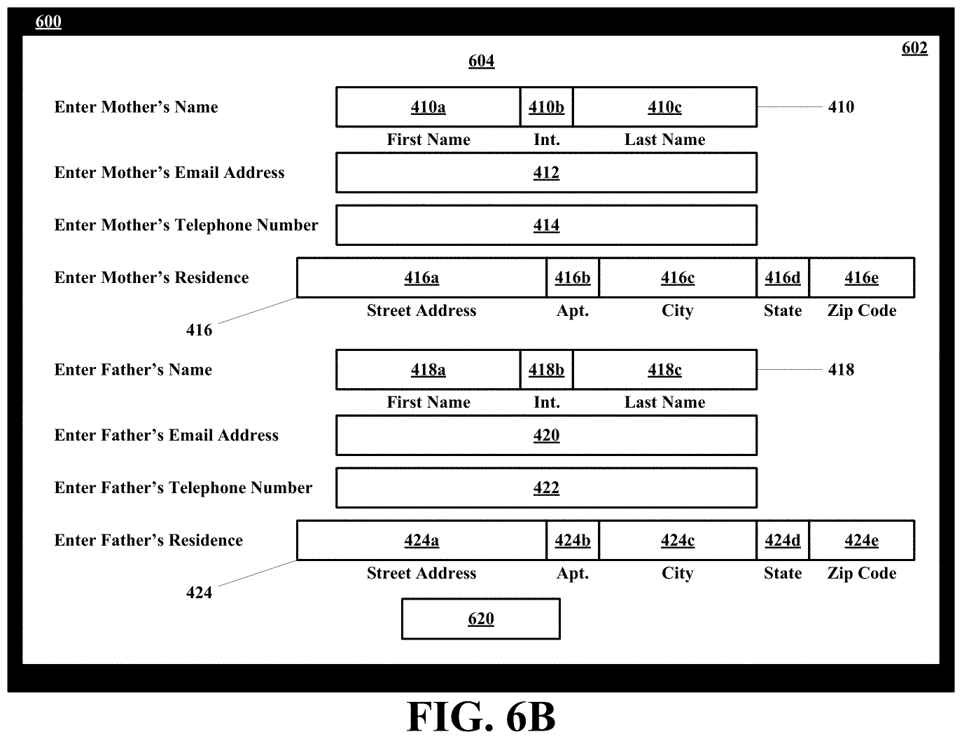

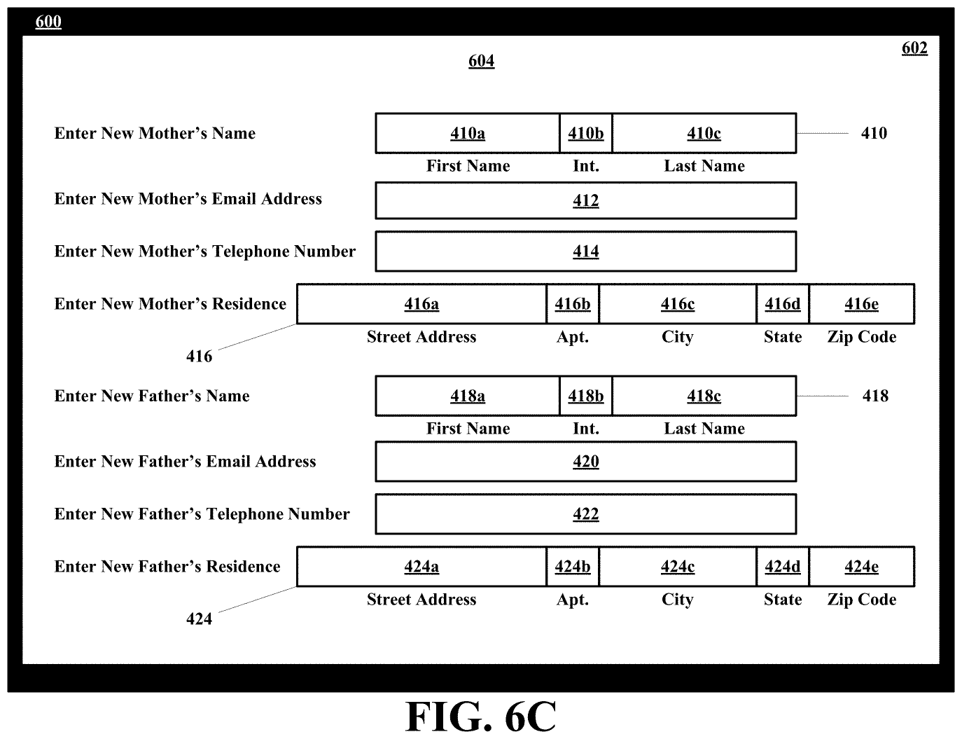

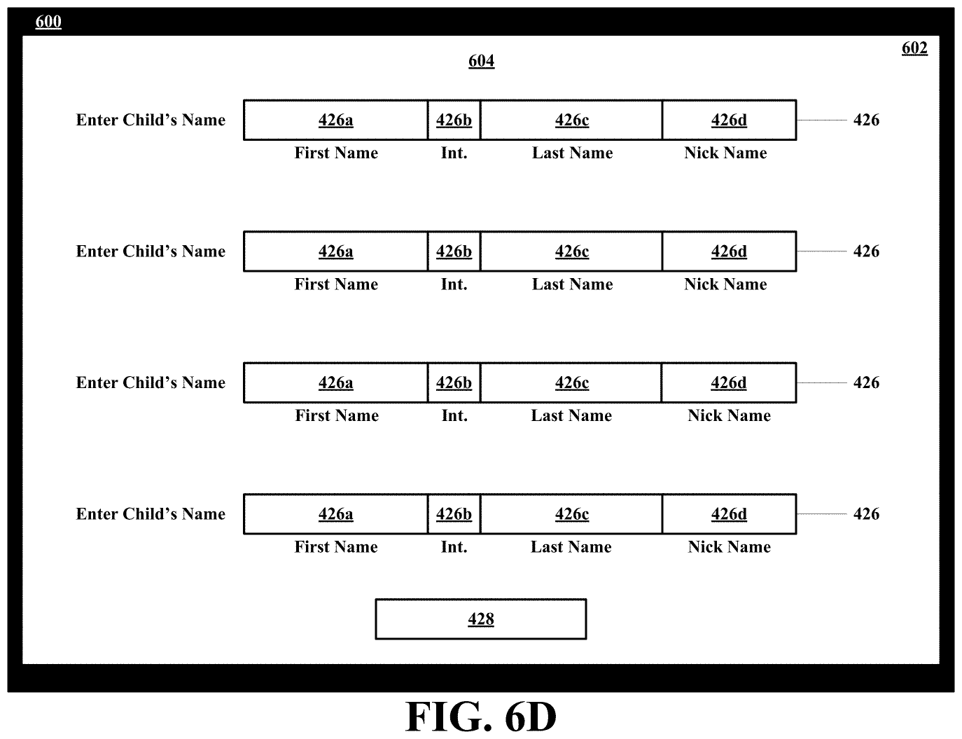

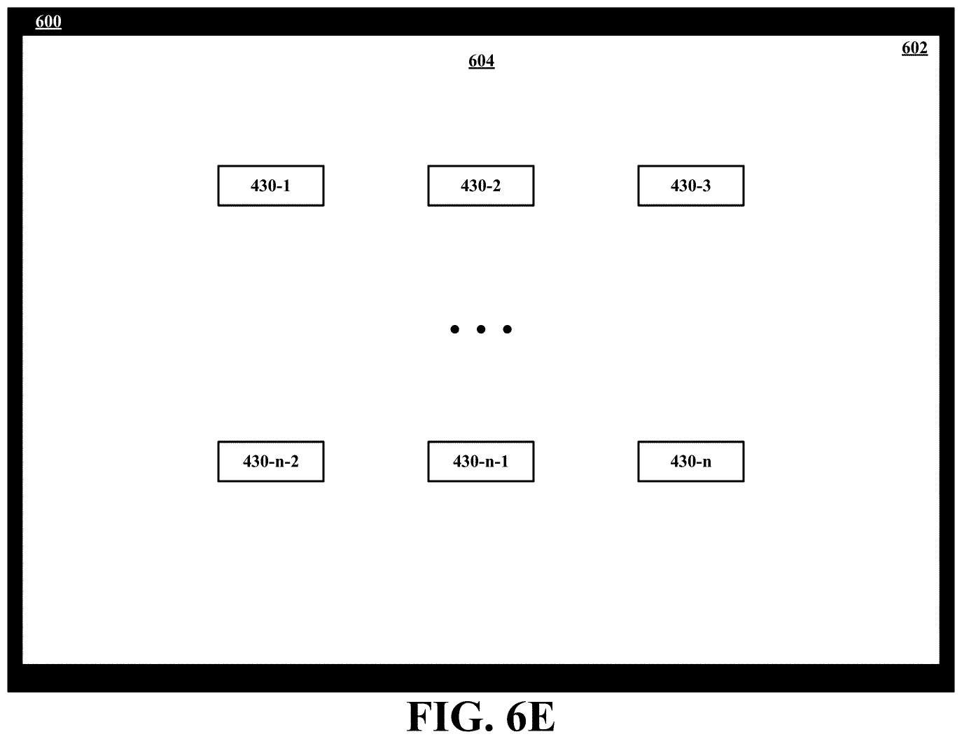

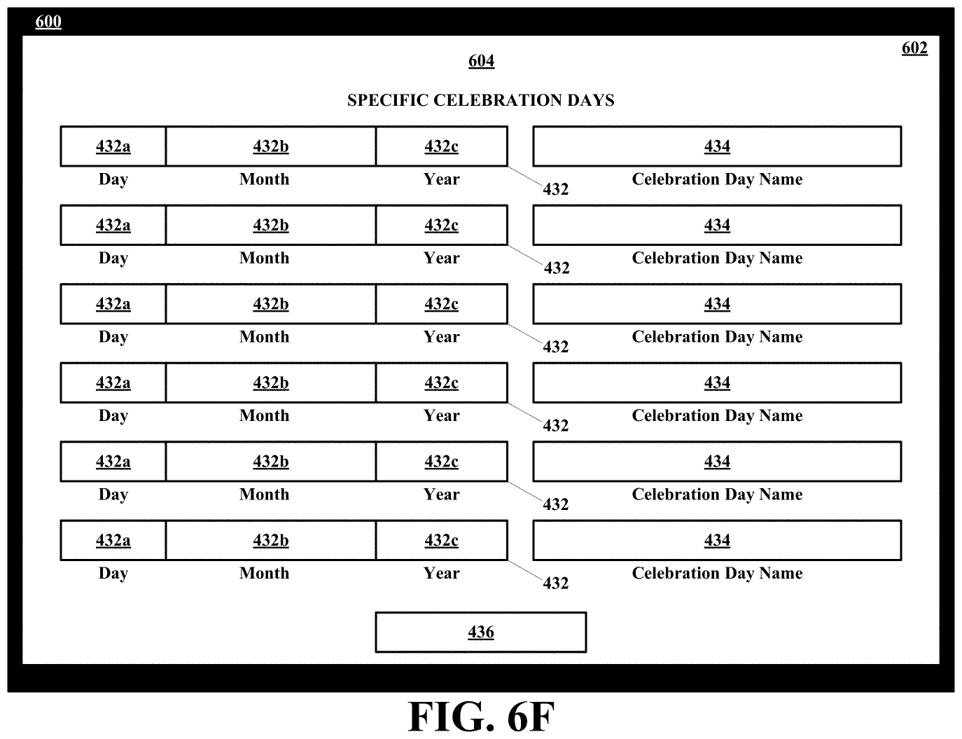

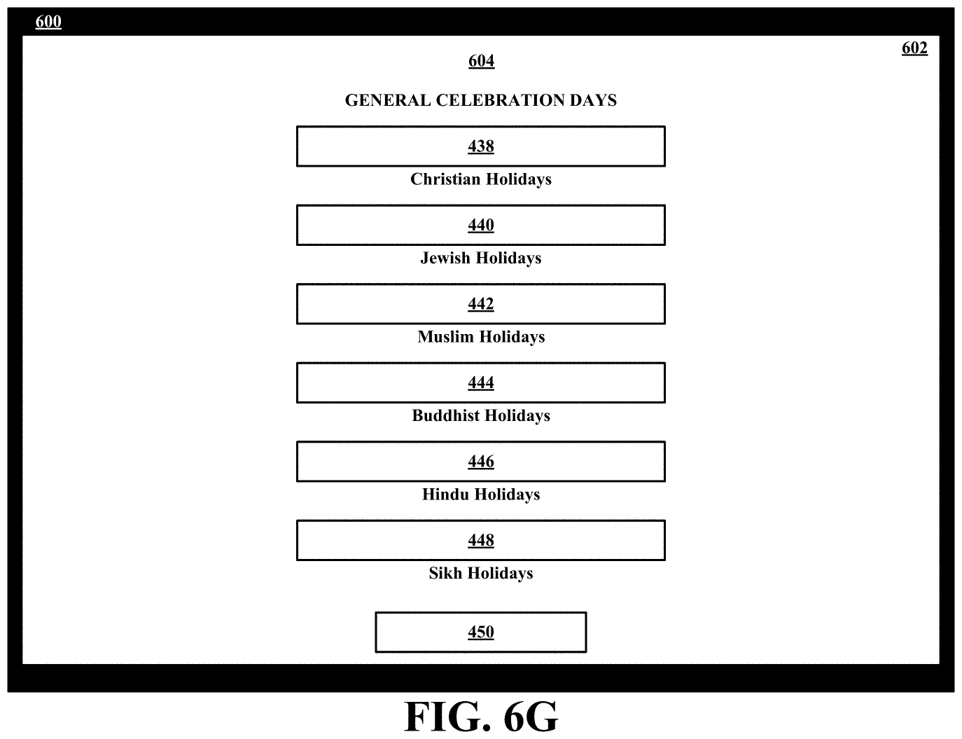

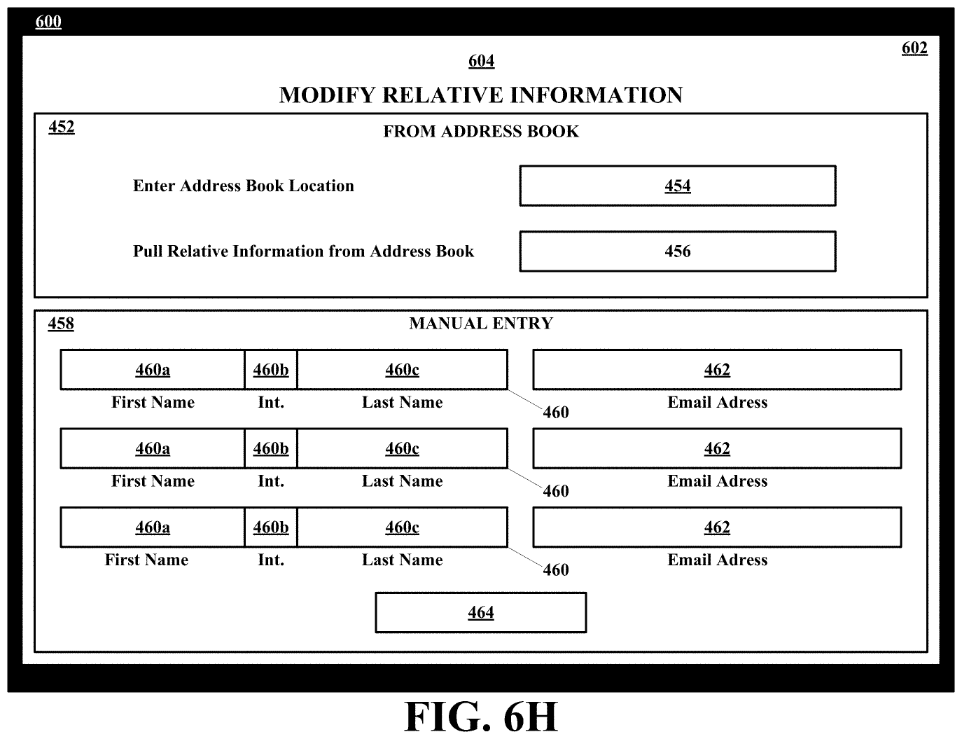

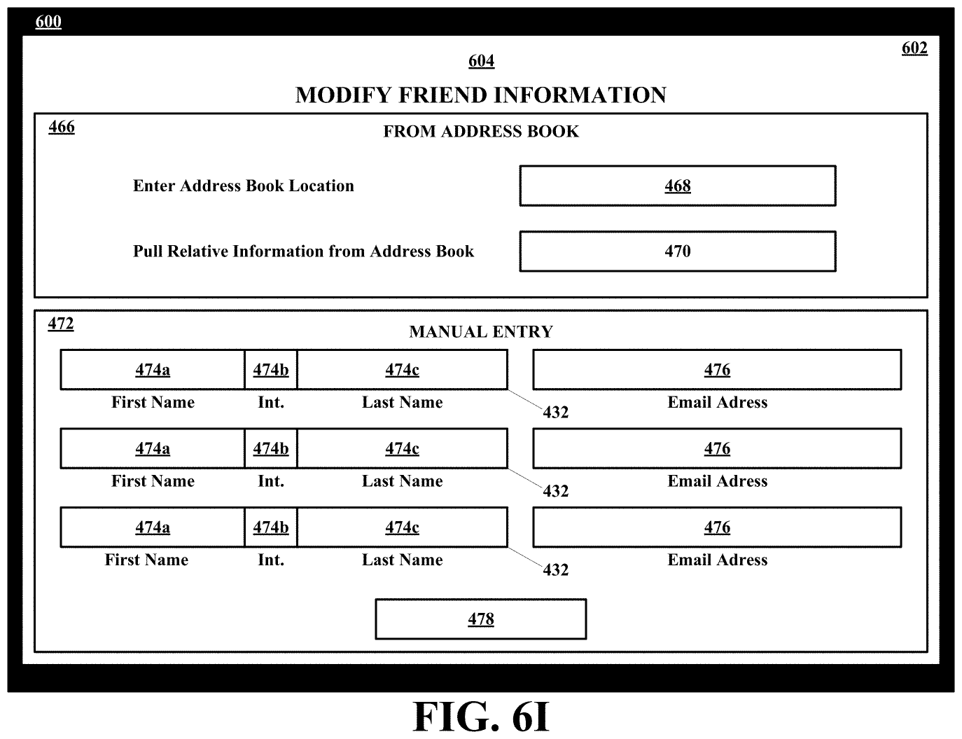

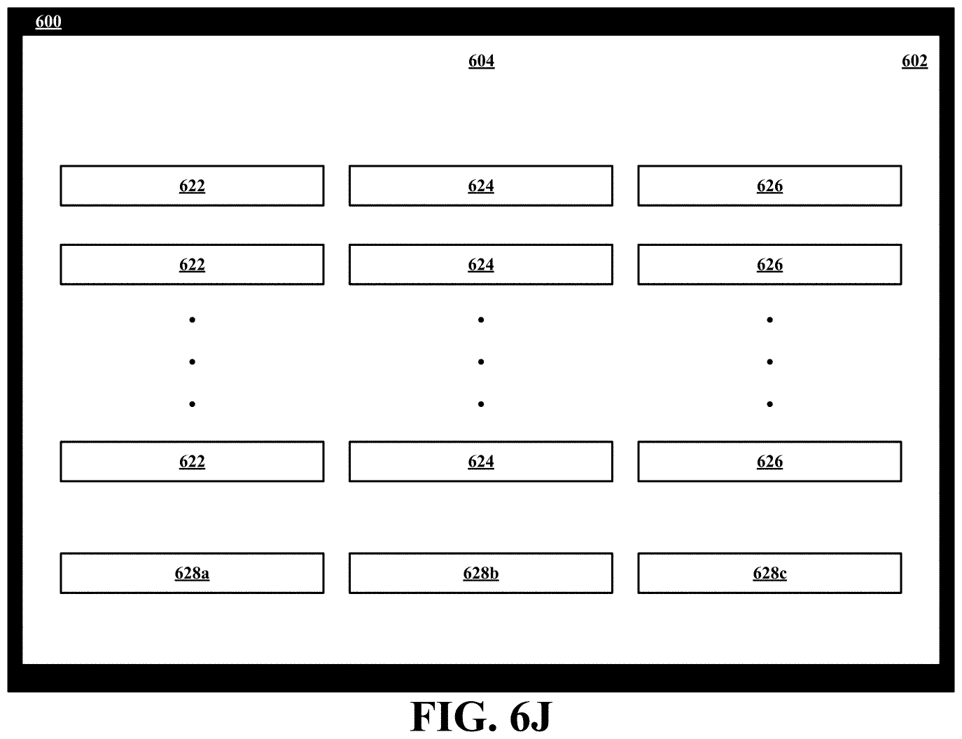

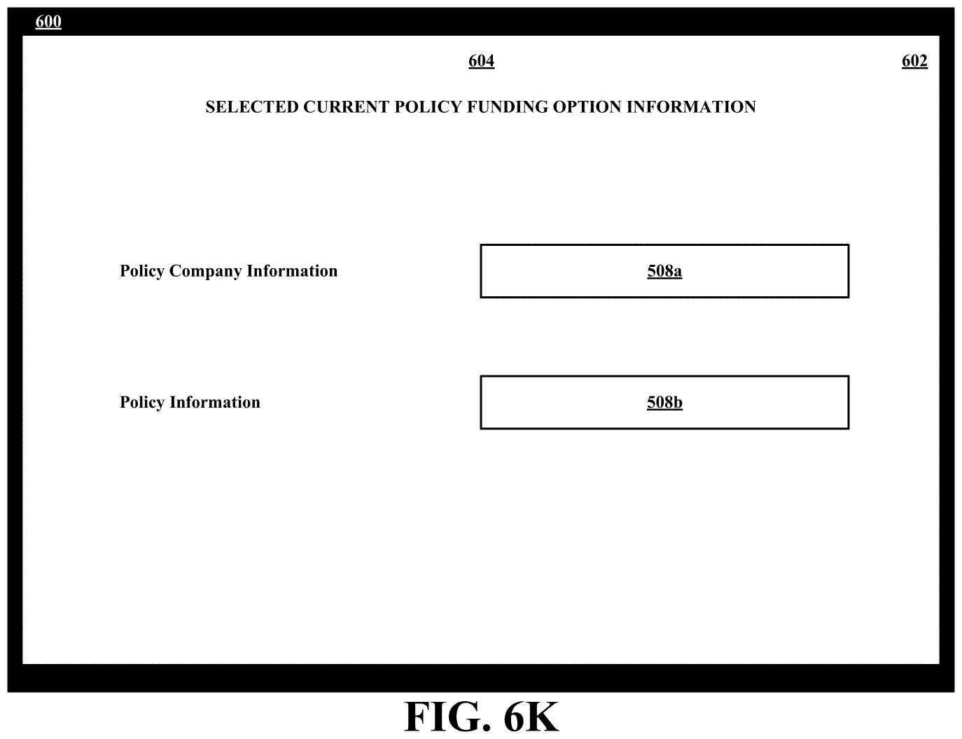

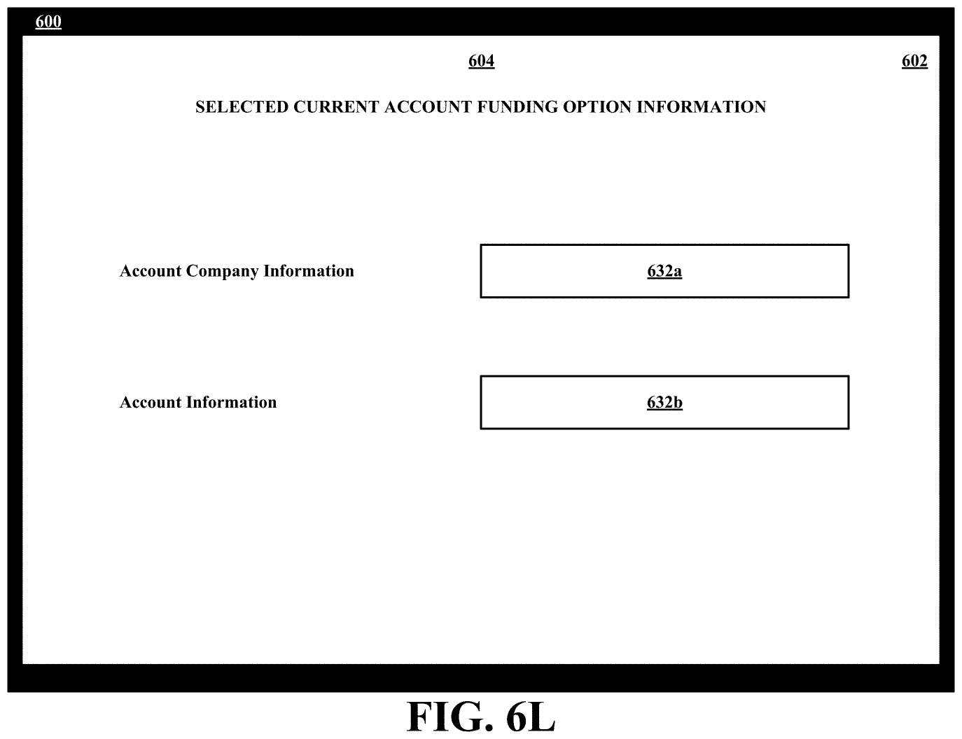

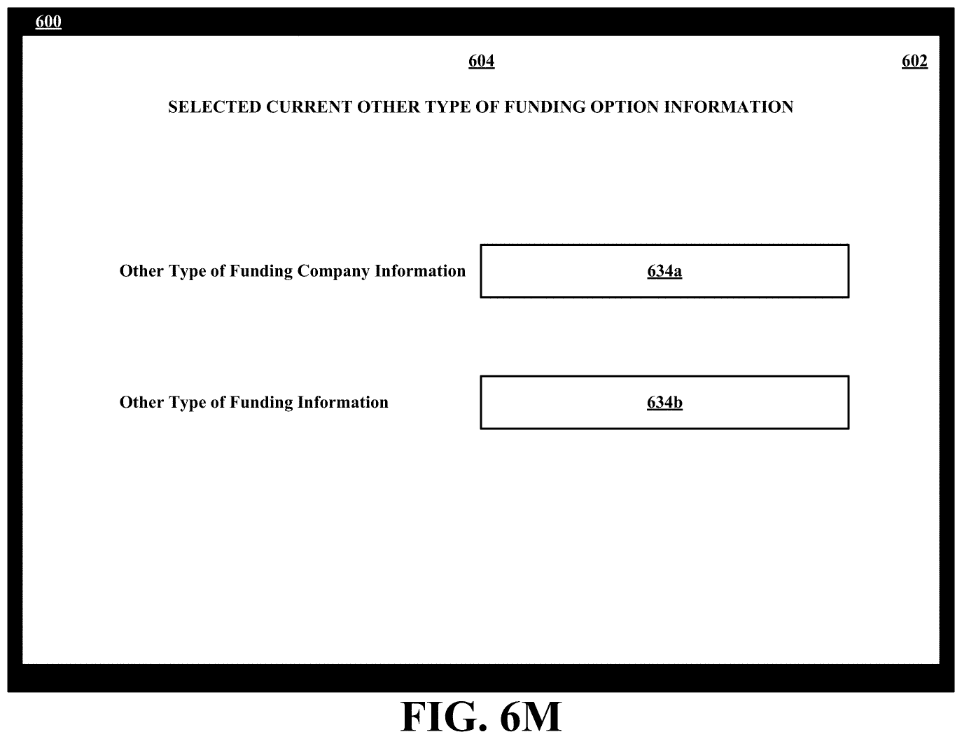

Referring now to FIGS. 6A-M, these figures depict a screen sequence for modifying previously entered data or entering new data. It should be recognized that the screen sequence FIGS. 6A-S may be configured for any user and any user specific persons.

Looking at FIG. 6A, the device, now generally 600, is shown to include a display 602 having an active window area 604. The window 604 includes a modify and/or add parent information box 606, a modify and/or add child information box 608, a modify and/or add specific celebration day information box 610, a modify and/or add general celebration day information box 612, a modify and/or add friend information box 614, a modify and/or add relative information box 616, and a modify and/or add funding option information box 618.

Modify and/or Add Parent Information

If the user selects the modify and/or add parent information box 606, then the system proceeds to FIG. 6B and the window 604 would now display, the mother's and father's information boxes including the enter mother's name box 410 having the first name entry location 410a, the initial entry location 410b, and the last name entry location 410c populated with the original information. The window 604 would also include the enter mother's email address box 412 and the enter mother's phone number box 414 also populated with the original information. The window 404 now also includes the enter mother's residence box 416 including a street address entry location 416a, an apartment number entry location 416b, a city entry location 416c, a state entry location 416d, and a zip code entry location 416e also populated with the original information. The window 604 now would also include the enter father's name box 418 having the first name entry location 418a, the initial entry location 418b, and the last name entry location 418c also populated with the original information. The window 404 also includes the enter father's email address box 420 and the enter father's phone number box 422 also populated with the original information. The window 404 also includes the enter father's residence box 424 including the street address entry location 424a, the apartment number entry location 424b, the city entry location 424c, the state entry location 424d, and the zip code entry location 424e also populated with the original information. The user may modify the information in any of the boxes. Again, while no submit box is shown in any of these screen shots, it is assumed that enter will result in submission of the data, but each screen may include a submit box (not shown).

Add New Parent

The window 604 would also include an add a parent box 620 and if selected the system would proceed to FIG. 6C and the window 604 would now include an enter mother's name box 410 having a first name entry location 410a, an initial entry location 410b, and a last name entry location 410c. The window 404 also now includes an enter mother's email address box 412 and an enter mother's phone number box 414. The window 404 now also includes an enter mother's residence box 416 including a street address entry location 416a, an apartment number entry location 416b, a city entry location 416c, a state entry location 416d, and a zip code entry location 416e. Again, while no submit box is shown in any of these screen shots, it is assumed that enter will result in submission of the data, but each screen may include a submit box (not shown). The window 604 would also include an enter father's name box 418 having a first name entry location 418a, an initial entry location 418b, and a last name entry location 418c. The window 404 also includes an enter father's email address box 420 and an enter father's phone number box 422. The window 404 also includes an enter father's residence box 424 including a street address entry location 424a, an apartment number entry location 424b, a city entry location 424c, a state entry location 424d, and a zip code entry location 424e. Of course, if the residence is the same, the entering “same in” the street address location will populate the mother's residency information in the father's residence box. Again, while no submit box is shown in any of these screen shots, it is assumed that striking the enter key will result in submission of the data, but each screen may include a submit box (not shown).

Modify and/or Add Child Information

If the user selects the modify and/or add child information box 608 and if selected the system would proceed to FIG. 6D and the window 604 would now display the enter child's name boxes 426 including the first name entry location 426a, the middle initial entry location 426b, the last name entry location 426c and the nick name entry location 426d, all populated with the original child information. The window 604 would also include the more children box 428, which if activated will bring additional child boxes 426. Adding or deleting children may simply be performed by modifying the original data and using the more box 428 to add additional children, which brings up the additional children and allows the user to enter new child. Again, modifying the information (removing, adding, altering) may have and entered via entering or the screen may include a submit box.

Modify and/or Add Specific Celebration Day Information

If the user selects the modify and/or add specific celebration day information box 610 and if selected the system would proceed to FIG. 6E, then the window 604 would now include the child boxes 430-1 through 430-n. The user may select each of the child boxes 430 so that the user may modify, add, and/or delete specific celebration day data for each child. In an alternate embodiment, the method may be configured so that when the parent enters in the child name and/or nick name, the system will jump to the relative and friend entry screens described above. Once the user selects a given child from the child boxes 430, the systems, apparatuses, interfaces, and/or applications proceed to FIG. 6F, where the window 604 is now shown to include the specific celebration day date boxes 432 including the day entry location 432a, the month entry location 432b, and the year entry location 432c, the specific celebration day name 434, and the add more specific celebration day box 436, which will bring up additional specific celebration days. The boxes in the window is populated with the existing information. Again, modifying the information (removing, adding, altering) may have and entered via entering or the screen may include a submit box.

Modify and/or Add General Celebration Day Information

If the user selects the modify general celebration day information box 612 and if selected the system would proceed to FIG. 6G, then the window 604 would now would include the holiday celebration days type boxes 438 through 448, and to more holiday celebration days box 450. The box 438, if selected, populates the general celebration days with appropriate Christian Holidays. The box 440, if selected, populates the general celebration days with appropriate Jewish Holidays. The box 442, if selected, populates the general celebration days with appropriate Muslim Holidays. The box 444, if selected, populates the general celebration days with appropriate Buddhist Holidays. The box 446, if selected, populates the general celebration days with appropriate Hindu Holidays. The box 438, if selected, populates the general celebration days with appropriate Sikh Holidays. The more box 450 allows the user to enter in specific alternate general holidays dates, generally just a day and month or a type such as Chinese New Year, which falls on different days for each or Thanksgiving, which occurs on a designated Thursday. In all of the date boxes, the boxes may include drop down windows for selecting day, months and years. The boxes in the window is populated with the existing information. Again, modifying the information (removing, adding, altering) may have and entered via entering or the screen may include a submit box.

Modify and/or Add Specific Relative Information

If the user selects the modify and/or add relative information box 614 and if selected the system would proceed to FIG. 6H, then the window 604 would now modify relative information screen including an address book entry portion 452 including an enter address book location box 454 and a pull relative information from the address book box 456. The boxes 454 and 456 are designed to permit the user to set up address book on the user's computer or computing device and direct the application to pull information from the indicated address book such as an Outlook address book or similar electronic address book. The boxes in the window is populated with the existing information. Again, modifying the information (removing, adding, altering) may have and entered via entering or the screen may include a submit box.

The window 404 also includes a manual entry portion 458 including an enter relative name box 460 including a first name entry location 460a, a middle initial entry location 460b, and a last name entry location 460c, an email address box 462, and a more box 464, which if selected pulls up additional enter relative boxes 460. The boxes in the window is populated with the existing information. Again, modifying the information (removing, adding, altering) may have and entered via entering or the screen may include a submit box.

Modify and/or Add Specific Friend Information

If the user selects the modify and/or add friend information box 616 and if selected the system would proceed to FIG. 6I, then the window 604 would now an modify friend information screen including an address book entry portion 466 including an enter address book location box 468 and a pull relative information from the address book box 470. The boxes 468 and 470 are designed to permit the user to set up an address box on a computer or computing device and direct the application to pull information from the address book such as an Outlook address book or similar electronic address book. The boxes in the window is populated with the existing information. Again, modifying the information (removing, adding, altering) may have and entered via entering or the screen may include a submit box.

The window 404 also includes a manual entry portion 472 including an enter relative name box 474 including a first name location 474a, a middle initial location 474b, and a last name location 474c, an email address box 476, and a more box 478, which if selected pulls up additional enter relative boxes 474. The boxes in the window is populated with the existing information. Again, modifying the information (removing, adding, altering) may have and entered via entering or the screen may include a submit box.

Modify and/or Add Funding Option Information

If the user selects the modify and/or funding option information box 618 and if selected the system would proceed to FIG. 6J and the window 604 would now include current policy funding option boxes 622, current account funding option boxes 624, current other funding option boxes 626, and an add policy funding option box 628a, an add account funding option box 628b, and an add other type of funding option box 628c.

If the user selects one of the current policy funding option boxes 622, then the systems, apparatuses, interfaces, and/or applications would proceed to the selected current policy funding option information screen as shown in FIG. 6K, where the window 604 now includes a selected current policy company information boxes 630a and a selected current policy information box 630b, populated with the original information. The user may modify the data (e.g., change type and/or information) or removal all information, which would have the effect of removing the funding option. The boxes in the window is populated with the existing information. Again, modifying the information (removing, adding, altering) may have and entered via entering or the screen may include a submit box.

If the user selects one of the current account funding option boxes 624, then the systems, apparatuses, interfaces, and/or applications would proceed to the selected current account funding option information screen as shown in FIG. 6L, where the window 604 now includes a selected current account company information boxes 632a and a selected current account information box 632b, populated with the original information. The user may modify the data (e.g., change type and/or information) or removal all information, which would have the effect of removing the funding option. The boxes in the window is populated with the existing information. Again, modifying the information (removing, adding, altering) may have and entered via entering or the screen may include a submit box.

If the user selects one of the current other type of funding option boxes 624, then the systems, apparatuses, interfaces, and/or applications would proceed to the selected current other type of funding option information screen as shown in FIG. 6M, where the window 604 now includes a selected current other type of funding company information boxes 634a and a selected current other type of funding information box 634b, populated with the original information. The user may modify the data (e.g., change type and/or information) or removal all information, which would have the effect of removing the funding option. The boxes in the window is populated with the existing information. Again, modifying the information (removing, adding, altering) may have and entered via entering or the screen may include a submit box.

If the user selects the add the policy funding option box 628a, then the systems, apparatuses, interfaces, and/or applications transfers control to the screen shot series of FIGS. 5B-H for adding a new policy.

If the user selects the add the account funding option box 628b, then the systems, apparatuses, interfaces, and/or applications transfer control to the screen shot series of FIGS. 5I-W for adding a new account.

If the user selects the add the other type of funding option box 628c, then the systems, apparatuses, interfaces, and/or applications transfer control to the screen shot series of FIGS. 5X-AB for adding a new other funding type account.

### Screen Sequence Depicting Relative and Friend Funding

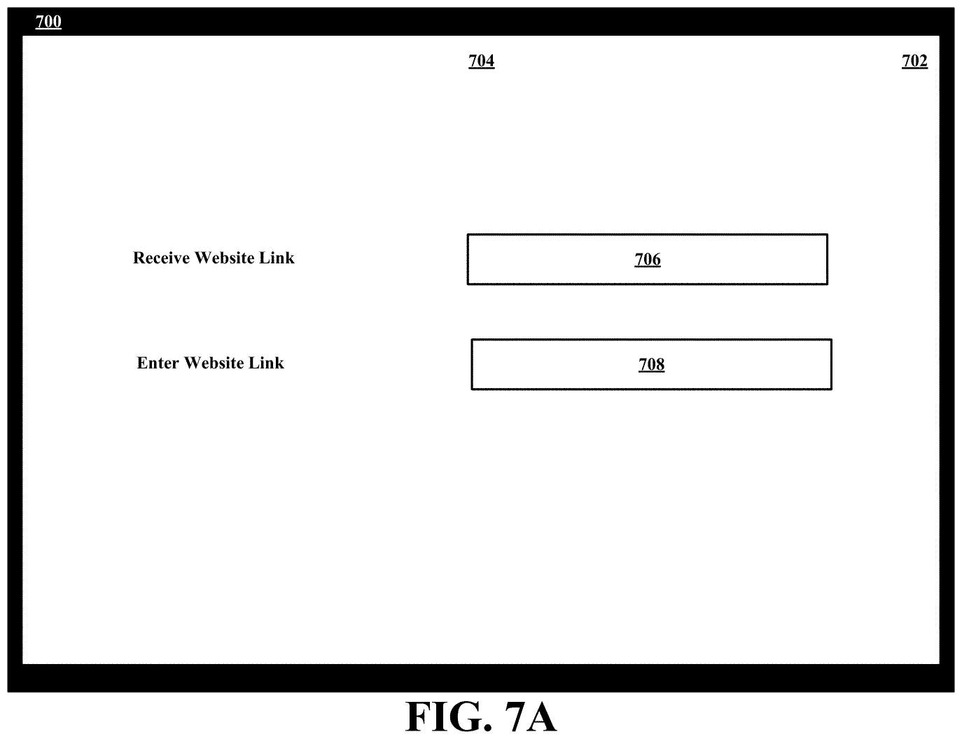

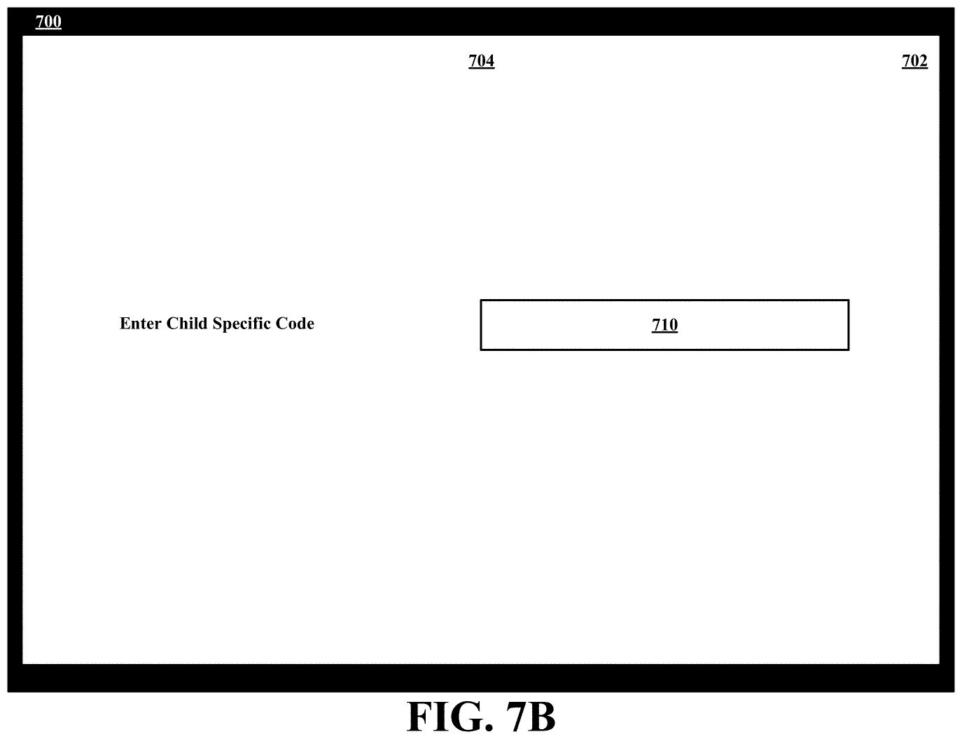

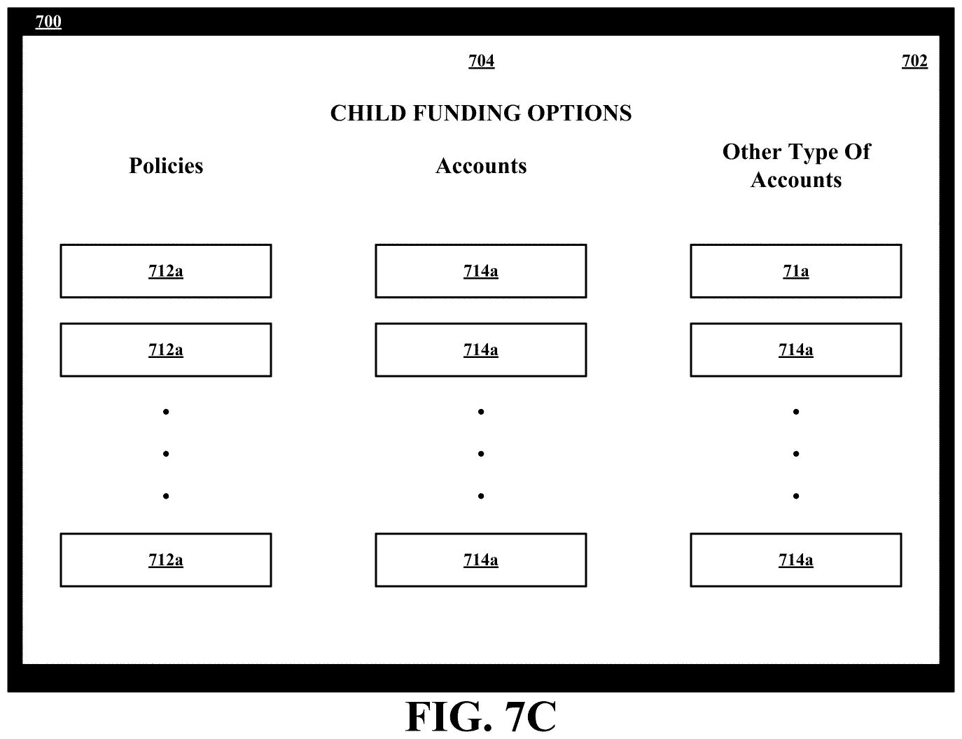

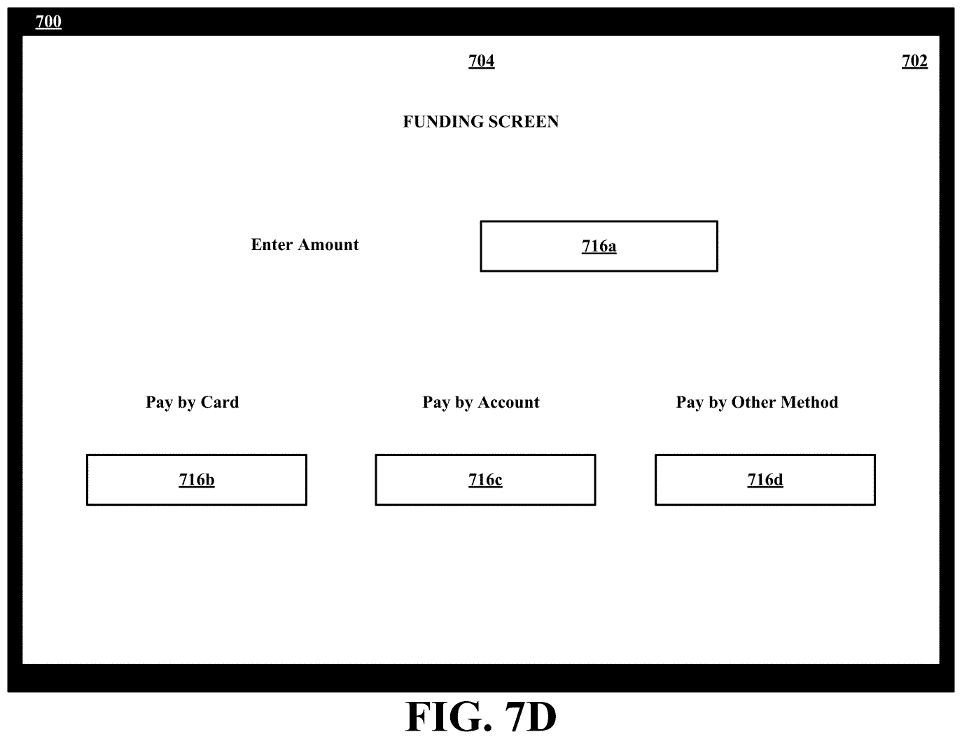

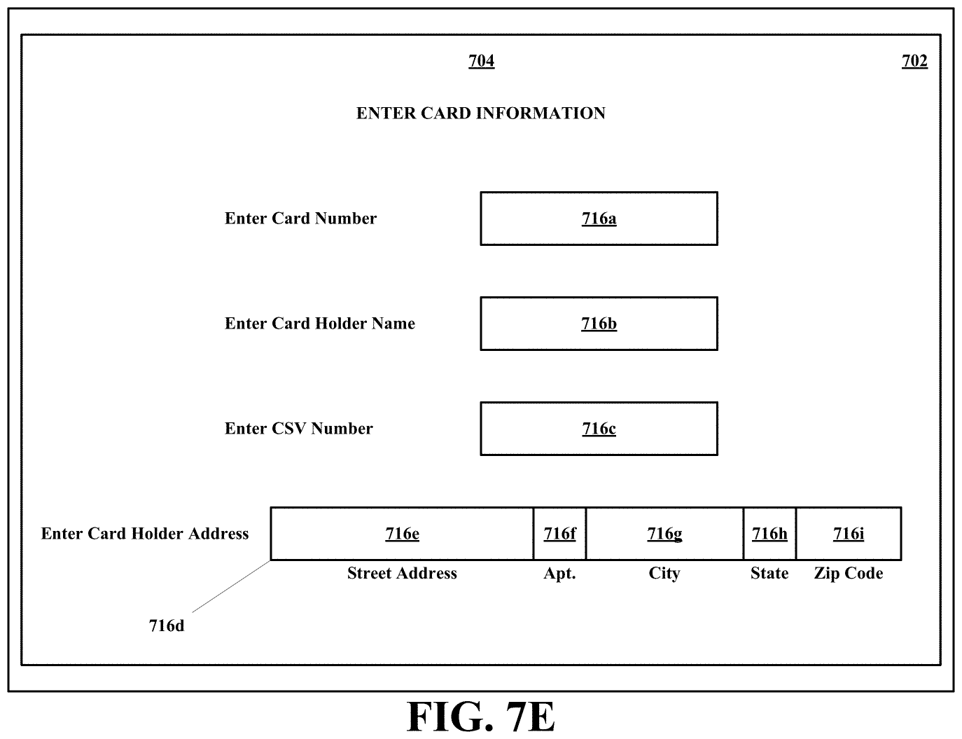

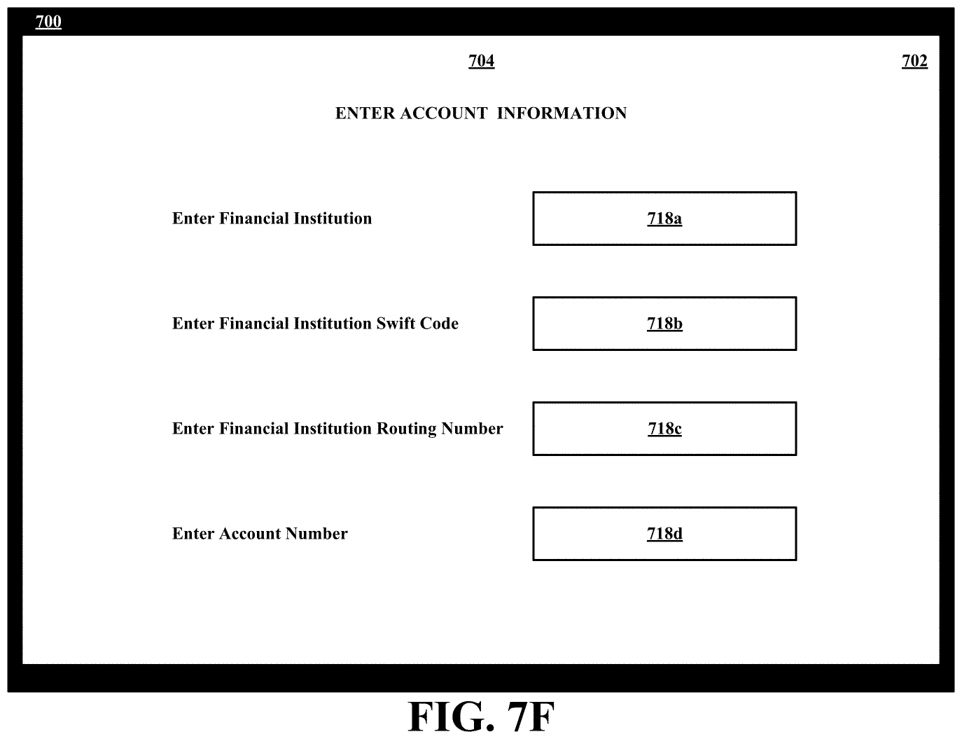

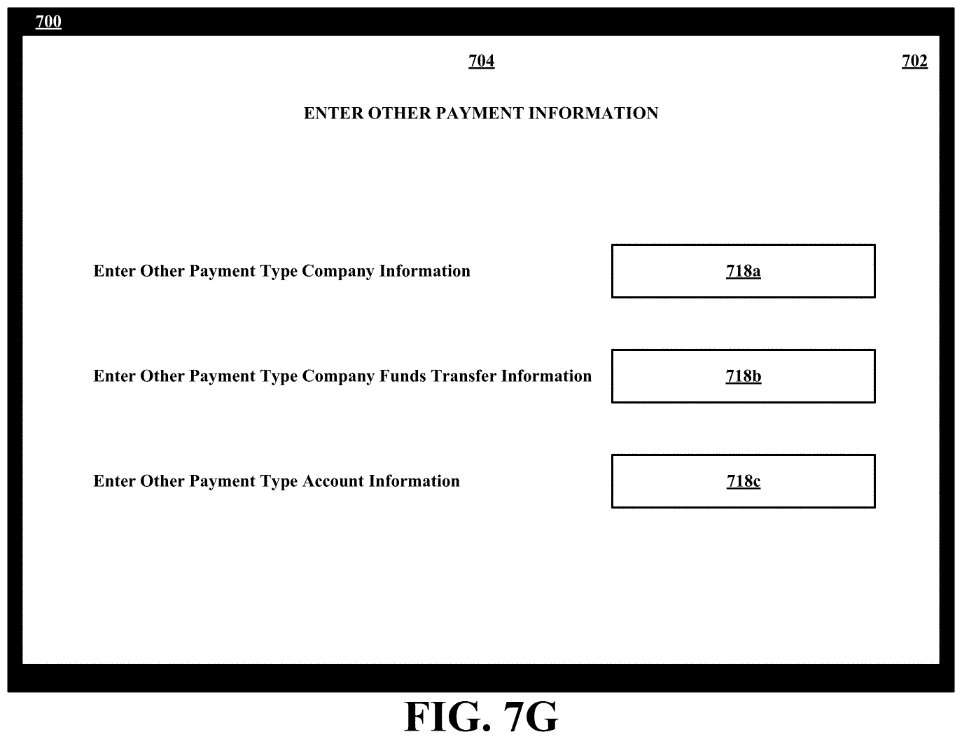

Referring now to FIGS. 7A-G, these figures depict a screen shot sequence for relatives and friends to transfer funds into one or more of the funding options created by the user. The device, now generally 700, is shown to include a display 702 having an active window area 704. It should be recognized that the screen sequence FIGS. 7A-D may be configured for any user and any user specific persons.

Looking at FIG. 7A, the window 704 includes a receive website link box 706 and an enter website link box 708. Alternatively, the systems, apparatuses, interfaces, and/or applications may be configured so that once received, the systems, apparatuses, interfaces, and/or applications automatically goes to the indicated website.

Looking at FIG. 7B, the window 704 now includes an enter child code box 710.

Looking at FIG. 7C, after entering the child code into the box 710, the window 704 now includes current child funding options including policy boxes 712a, account boxes 712b, and other type of account boxes 712c.

Once a relative or friend selects a particular policy box 712a, a particular account box 712b, or a particular other type of account box 712c, then the systems, apparatuses, interfaces, and/or applications proceeds to FIG. 7D for funding the selected policy, account, or other type of account. The window 704 now includes an amount box 714a, a pay by card box 714b, a pay by account box 714b, and a pay by other method box 714d.

If the relative or friend selects the pay by card box 714b, then the systems, apparatuses, interfaces, and/or applications proceeds to FIG. 7E for entering card information. The window 704 now includes an enter card number box 716a, an enter card holder name box 716b, an enter CSV number box 716c, and an enter card holder address box 716d including an enter street address box 716e, an enter apartment number box 716f, an enter city box 716g, an enter state box 716h, and an enter zip code box 716i.

If the relative or friend selects the pay by account box 716c, then the systems, apparatuses, interfaces, and/or applications proceeds to FIG. 7F for entering account information. The window 704 now includes an enter financial institution box 718a, an enter financial institution swift code box 718b, an enter financial institution routing number box 718c, and an enter account number box 718d.

If the relative or friend selects the pay by other method box 14c, then the systems, apparatuses, interfaces, and/or applications proceeds to FIG. 7G for entering other payment method information. The window 704 now includes an enter other payment type company box 718a, an enter other payment type transfer information box 718b, and an enter other payment type account information box 718c.

### Closing Paragraph of the Disclosure

All references cited herein are incorporated by reference. Although the disclosure has been disclosed with reference to its preferred embodiments, from reading this description those of skill in the art may appreciate changes and modification that may be made which do not depart from the scope and spirit of the disclosure as described above and claimed hereafter.

We claim:

1. A system comprising:
user devices,
relative devices,
friend devices, and
servers,
wherein the user devices are configured to:
install an application onto a user device,
open the application on the user device,
if the user is a first time user, then:
enter a user name, a user password, a user phone number, and a user email address into server databases,
enter user data and user payment method data into the server databases,
enter specific person data, specific person celebration days, specific person funding options, person relatives data, and person friends data into the server databases,
if all persons have not been entered, repeat enter specific person data, specific person celebration days, specific person funding options, person relatives data, and person friends data into the server databases,
if all persons have been entered, then modify entered data in the server databases,
wherein the servers are configured to:
test for a celebration day in the server databases,
if a celebration day is detected, determine the person associated with the celebration day and send a website link and a person specific code, otherwise continue to test for a celebration day,
wherein the devices of the relatives and friends are configured to:
receive the website link and the person specific code,
display the funding options associated with the person specific code,
select a funding option,
enter an amount of funds to be transferred to the selected funding option,
display payment types,
select a funding type,
enter information associated with the selected funding type,
transfer the amount of funds,
receive a funds transfer confirmation, and
wherein the servers are further configured to:
continue to test for a celebration day.

2. The system of claim 1, wherein the servers are further configured to:
after the entering the user name, the user password, the user phone number, and the user email address, verifying user identify including:
selecting a verification mode,
sending a verification code,
entering the verification code, and
if the verification code is incorrect, then stopping the method.

3. The system of claim 1, wherein the servers are further configured to:
after the entering the amount of funds, verifying relative or friend identify including:
selecting a verification mode,
sending a verification code,
entering the verification code, and
if the verification code is incorrect, then stopping the method.

4. A method implementing system of claims ?, comprising:
installing an application on a user device,
opening and activating with the application on the user device,
if the user is a first time user, then:
entering a user name, a user password, a user phone number, and a user email address,
entering user data and user payment method data,
entering specific person data, specific person celebration days, specific person funding options, person relatives data, and person friends data,
if all persons have not been entered, repeating entering specific person data, specific person celebration days, specific person funding options, person relatives data, and person friends data,
if all persons have been entered, then modifying entered data,
on databases associated the servers, testing for a celebration day,
if a celebration day is detected, determining the person associated with the celebration day and sending a website and a person specific code, otherwise continue testing for a celebration day,
once the website link and person specific code is received on a relative or friend device,
entering the website link and the person specific code,
displaying the funding options associated with the person specific code on the relative or friend device,
selecting a funding option,
entering an amount of funds to be transferred to the selected funding option,
displaying payment types,
selecting a funding type,
entering information associated with the selected funding type,
submitting payment,
sending payment confirmation to the relative or friend device, and
returning to testing for a celebration day.

5. The method of claim 4, further comprising:
after the entering the user name, the user password, the user phone number, and the user email address, verifying user identify including:
selecting a verification mode,
sending a verification code,
entering the verification code, and
if the verification code is incorrect, then stopping the method.

6. The method of claim 4, further comprising:
after the entering the amount of funds, verifying relative or friend identify including:
selecting a verification mode,
sending a verification code,
entering the verification code, and
if the verification code is incorrect, then stopping the method.
